(19) United States
(12) Patent Application Publication
(10) Pub. No.: US 2017/0257885 A1
(43) Pub. Date: Sep. 7, 2017

(54) FTM PROTOCOL ENHANCEMENTS TO SUPPORT SBS/DBS MODE

(71) Applicant: QUALCOMM Incorporated, San Diego, CA (US)

(72) Inventors: Xiaoxin Zhang, Sunnyvale, CA (US); James Cho, Mountain View, CA (US); Carlos Horacio Aldana, Mountain View, CA (US)

(21) Appl. No.: 15/426,255

(22) Filed: Feb. 7, 2017

Related U.S. Application Data
(60) Provisional application No. 62/301,889, filed on Mar. 1, 2016.

(51) Int. Cl. H04W 74/00; H04W 24/08; H04L 5/00

(52) U.S. Cl. CPC H04W 74/008; H04L 5/0055; H04W 24/08; H04W 84/12

(57) ABSTRACT

This disclosure provides systems, methods and apparatuses for performing ranging operations between a transmitting device and one or more receiving devices using one or more wireless channels. In some implementations, a transmitting device may substantially concurrently exchange, on each of a plurality of wireless channels, a corresponding set of FTM frames and acknowledgement (ACK) frames with a receiving device, and then determine a distance to the receiving device based on the plurality of exchanged sets of FTM and ACK frames. In some other implementations, the transmitting device may substantially concurrently exchange, with each of a plurality of receiving devices, a corresponding set of FTM frames and ACK frames on a corresponding one of a plurality of wireless channels, and then determine a distance to each of the plurality of receiving devices based on the corresponding sets of exchanged FTM and ACK frames.

### CROSS-REFERENCE TO RELATED APPLICATIONS

This patent application claims priority to U.S. Provisional Patent Application No. 62/301,889 filed on Mar. 1, 2016 entitled “FTM PROTOCOL ENHANCEMENTS TO SUPPORT SBS/DBS MODE,” and assigned to the assignee hereof. The disclosure of the prior Application is considered part of and is incorporated by reference in this patent application.

### TECHNICAL FIELD

This disclosure relates generally to wireless networks, and specifically to ranging operations performed between wireless devices.

### DESCRIPTION OF THE RELATED TECHNOLOGY

The recent proliferation of Wi-Fi® access points in wireless local area networks (WLANs) has made it possible for positioning systems to use these access points for position determination, especially in areas where there is a large concentration of active Wi-Fi access points (such as urban cores, shopping centers, office buildings, sporting venues, and so on). For example, a wireless device such as a cell phone or tablet computer may use the round trip time (RTT) of signals exchanged with an access point (AP) to determine the distance between the wireless device and the AP. Once the distances between the wireless device and three APs having known locations are determined, the location of the wireless device may be determined using trilateration techniques.

Because ranging operations are becoming more important for position determination, it is desirable to increase the speed with which ranging operations may be performed without sacrificing accuracy. In addition, it is also desirable to increase the speed with which a wireless device may perform ranging operations with a plurality of other devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless network to perform ranging operations between a transmitting device and a receiving device on a plurality of wireless channels. The transmitting device can transmit, on at least one of the plurality of wireless channels, a fine timing measurement (FTM) request frame to the receiving device. The FTM request frame can identify the plurality of wireless channels to be used for the ranging operation. In some aspects, the FTM request frame can indicate at least one of a capability to transmit signals on multiple wireless channels at the same time (or substantially at the same time) and an indication of how many different wireless channels upon which the transmitting device is capable of simultaneous operations (or substantially simultaneous operations). In some other aspects, the FTM request frame can indicate at least one of a frequency band, a channel number, and a channel bandwidth of each of the identified plurality of wireless channels. The transmitting device can receive, on the at least one of the plurality of wireless channels, a response frame from the receiving device. The transmitting device can substantially concurrently exchange, on each of the plurality of wireless channels, a corresponding set of FTM frames and acknowledgement (ACK) frames with the receiving device. The transmitting device can determine a distance to the receiving device based on the plurality of exchanged sets of FTM and ACK frames. In some aspects, the transmitting device can exchange, on each of the plurality of wireless channels, a corresponding set of FTM frames and ACK frames with the receiving device at the same or similar time.

In some implementations, the transmitting device can exchange corresponding sets of FTM frames and ACK frames with the receiving device by receiving a plurality of first FTM frames from the receiving device on respective ones of the plurality of wireless channels, transmitting a plurality of first ACK frames to the receiving device on respective ones of the plurality of wireless channels, and receiving a plurality of second FTM frames from the receiving device on respective ones of the plurality of wireless channels. In some aspects, each of the plurality of second FTM frames can include time of arrival (TOA) and time of departure (TOD) information of the first ACK frame and the first FTM frame, respectively, exchanged on a corresponding one of the plurality of wireless channels.

Another innovative aspect of the subject matter described in this disclosure can be implemented as a method for performing ranging operations between a transmitting device and a receiving device on a plurality of wireless channels. The method can include transmitting, on at least one of the plurality of wireless channels, a FTM request frame to the receiving device; receiving, on the at least one of the plurality of wireless channels, a response frame from the receiving device; and substantially concurrently exchanging, on each of the plurality of wireless channels, a corresponding set of FTM frames and ACK frames with the receiving device. In some aspects, the method also can include determining a distance to the receiving device based on the plurality of exchanged sets of FTM and ACK frames.

Another innovative aspect of the subject matter described in this disclosure can be implemented in a non-transitory computer readable medium. The non-transitory computer-readable medium can comprise instructions that, when executed by a transmitting device, cause the transmitting device to perform a ranging operation with a receiving device on a plurality of wireless channels. The number of operations can include transmitting, on at least one of the plurality of wireless channels, a FTM request frame to a receiving device; receiving, on the at least one of the plurality of wireless channels, a response frame from the receiving device; and substantially concurrently exchanging, on each of the plurality of wireless channels, a corresponding set of FTM frames and ACK frames with the receiving device. In some aspects, the number of operations also can include determining a distance to the receiving device based on the plurality of exchanged sets of FTM and ACK frames.

Another innovative aspect of the subject matter described in this disclosure can be implemented in a transmitting device. The transmitting device can include means for transmitting, on at least one of a plurality of wireless channels, a FTM request frame to a receiving device; means for receiving, on the at least one of the plurality of wireless channels, a response frame from the receiving device; and means for substantially concurrently exchanging, on each of the plurality of wireless channels, a corresponding set of FTM frames and ACK frames with the receiving device. In some aspects, the transmitting device also can include means for determining a distance to the receiving device based on the plurality of exchanged sets of FTM and ACK frames.

Another innovative aspect of the subject matter described in this disclosure can be implemented as a method for performing ranging operations between a transmitting device and a plurality of receiving devices. The method can include receiving, from each of the plurality of receiving devices, an indication of single-channel operation and an indication of a wireless channel upon which the corresponding receiving device operates; transmitting, to each of the plurality of receiving devices, a FTM request frame on a corresponding one of the plurality of indicated wireless channels; receiving, from each of the plurality of receiving devices, a response frame on the corresponding one of the plurality of indicated wireless channels; and substantially concurrently exchanging, with each of the plurality of receiving devices, a corresponding set of FTM frames and ACK frames on the corresponding one of the plurality of indicated wireless channels. In some aspects, the method also can include determining a distance to each of the plurality of receiving devices based on the corresponding sets of exchanged FTM and ACK frames.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a block diagram of an example wireless system.

FIG. 2 is a block diagram of an example wireless device.

FIG. 3 is a signal diagram of an example ranging operation.

FIG. 4 is a signal diagram of another example ranging operation.

FIG. 5A is a signal diagram of an example ranging operation.

FIG. 5B is a sequence diagram depicting the example ranging operation of FIG. 5A.

FIG. 5C is a signal diagram of another example ranging operation.

FIG. 5D is a sequence diagram depicting the example ranging operation of FIG. 5C.

FIG. 5E is a signal diagram of another example ranging operation.

FIG. 5F is a sequence diagram depicting the example ranging operation of FIG. 5E.

FIG. 5G is a signal diagram of another example ranging operation.

FIG. 5H is a sequence diagram depicting the example ranging operation of FIG. 5G.

FIG. 6A depicts an example management frame.

FIG. 6B depicts an example co-located basic service set identification (BSSID) list sub-element.

FIG. 7A depicts an example FTM request frame.

FIG. 7B depicts an example FTM frame.

FIG. 8A depicts an example multi-channel simultaneous capability information element (IE).

FIG. 8B depicts an example channel information field.

FIG. 9 shows an illustrative flow chart depicting an example ranging operation.

FIG. 10 shows an illustrative flow chart depicting another example ranging operation.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Implementations of the subject matter described in this disclosure may be used to perform ranging operations between wireless devices on a plurality of wireless channels at the same time, or at substantially the same time. For some implementations, a wireless device can exchange a plurality of sets of ranging frames with a receiving device on a plurality of different wireless channels, and determine a plurality of RTT values based on the plurality of sets of exchanged ranging frames. The wireless device can combine (such as by averaging in some implementations) the plurality of determined RTT values to determine a more accurate RTT estimate indicative of the distance between itself and the receiving device. Each set of exchanged ranging frames can include a fine timing measurement (FTM) frame and an acknowledgement (ACK) frame, and the wireless device can determine a distance to the receiving device based on a plurality of exchanged sets of FTM and ACK frames. In some aspects, the wireless device can exchange the plurality of sets of ranging frames with the receiving device on the plurality of different wireless channels at approximately the same or similar time.

In some implementations, each set of ranging frames can be exchanged concurrently or at least substantially concurrently. For one example, each set of ranging frames can be exchanged concurrently when all transceiver chains of the wireless device are synchronized with each other and when all transceiver chains of the receiving device are synchronized with each other. For another example, each set of ranging frames can be exchanged substantially concurrently, such as less than one second of each other, or even less than one half second of each other, when there is a timing mismatch or phase offset between the transceiver chains of the wireless device or when there is a timing mismatch or phase offset between the transceiver chains of the receiving device.

In some implementations, a wireless device can perform substantially concurrent ranging operations with a plurality of receiving devices. In some aspects, the wireless device can receive, from each of the plurality of receiving devices, an indication of single-channel operation and an indication of a wireless channel upon which the corresponding receiving device operates. The wireless device can substantially concurrently exchange, with each of the plurality of receiving devices, a corresponding set of FTM frames and ACK frames on the corresponding one of the plurality of indicated wireless channels. The wireless device can determine a distance to each of the plurality of receiving devices based on the corresponding sets of exchanged FTM and ACK frames.

Particular implementations of the subject matter described in this disclosure can be implemented to realize one or more of the following potential advantages. Because the plurality of sets of ranging frames are concurrently (or substantially concurrently) exchanged between the wireless devices, the example ranging operations disclosed herein consume less time than conventional ranging operations in which a plurality of sets of ranging frames are sequentially exchanged between wireless devices, without sacrificing ranging accuracy. In addition, by concurrently (or substantially concurrently) exchanging ranging frames with each of a plurality of receiving devices on a different wireless channel, the wireless device can simultaneously (or substantially simultaneously) range the plurality of receiving devices, thereby allowing the wireless device to more quickly determine the distances between itself and each of the plurality of receiving devices. More specifically, the wireless device can determine the distances between itself and three or more receiving devices having known locations, and use any suitable trilateration technique to determine its actual location based on the determined distances. Because the distances between the wireless device and multiple receiving devices can be determined at the same time (or at substantially the same time), the wireless device can more quickly determine the distances between itself and the multiple receiving devices, for example, as compared to sequentially performing ranging operations with each of the multiple receiving devices. As used herein, the term “single-band simultaneous (SBS)” may refer to a capability of a wireless device to simultaneously transmit and receive signals on a plurality of different channels within a single frequency band (such as the 2.4 GHz frequency band), and the term “dual-band simultaneous (DBS)” may refer to a capability of a wireless device to simultaneously transmit and receive signals on a plurality of different channels within at least two different frequency bands (such as the 2.4 GHz frequency band and the 5 GHz frequency band). For one example, a wireless device capable of SBS operations may simultaneously transmit and receive signals on multiple channels (such as on the “social channels” 1, 6, and 11) of the 2.4 GHz band. For another example, a wireless device capable of DBS operations may simultaneously transmit and receive signals on one or more of the 2.4 GHz channels and on one or more of the 5 GHz channels.

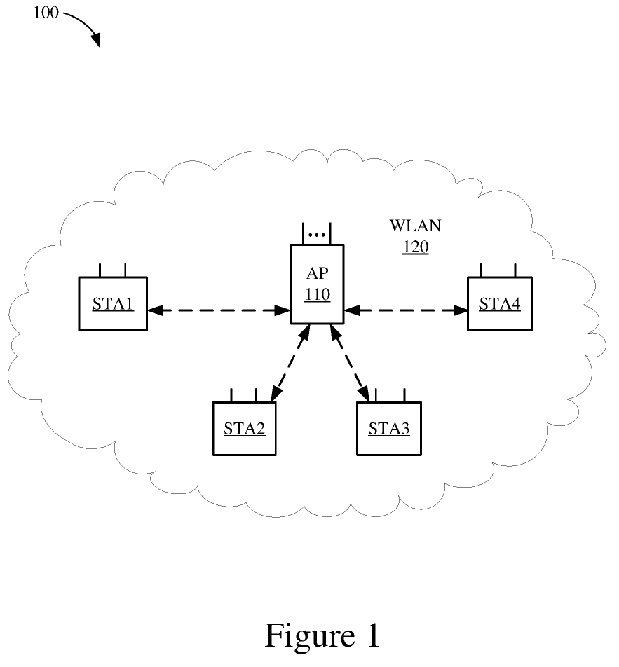

FIG. 1 is a block diagram of an example wireless system 100. The wireless system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique media access control (MAC) address that is programmed therein by, for example, the manufacturer of the access point. Similarly, each of stations STA1-STA4 is also assigned a unique MAC address. For some implementations, the wireless system 100 may correspond to a multiple-input multiple-output (MIMO) wireless network, and may support single-user MIMO (SU-MIMO) and multi-user (MU-MIMO) communications. Further, although the WLAN 120 is depicted in FIG. 1 as an infrastructure BSS, for other implementations, WLAN 120 may be an IBSS, an ad-hoc network, or a peer-to-peer (P2P) network (such as operating according to the Wi-Fi Direct protocols).

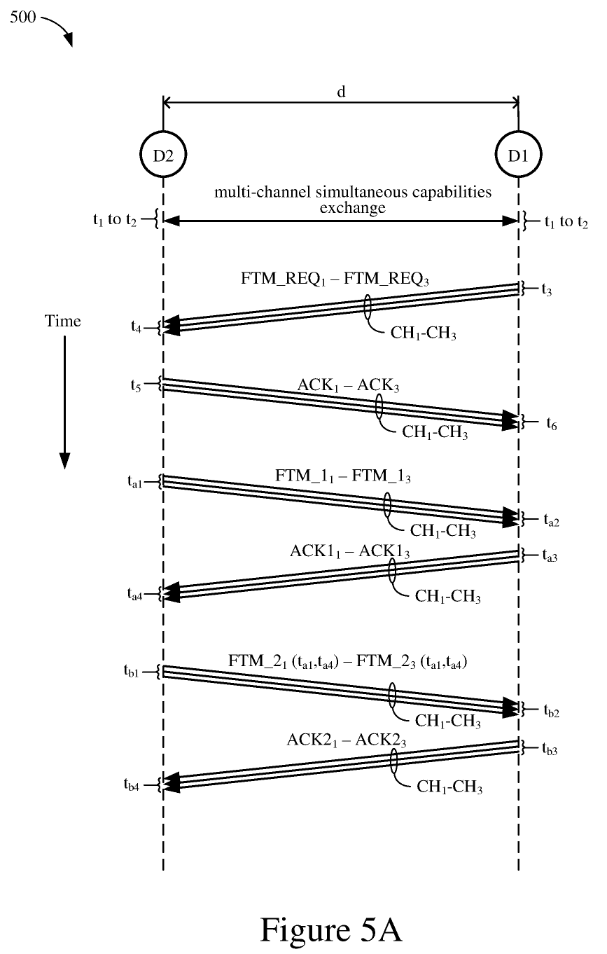

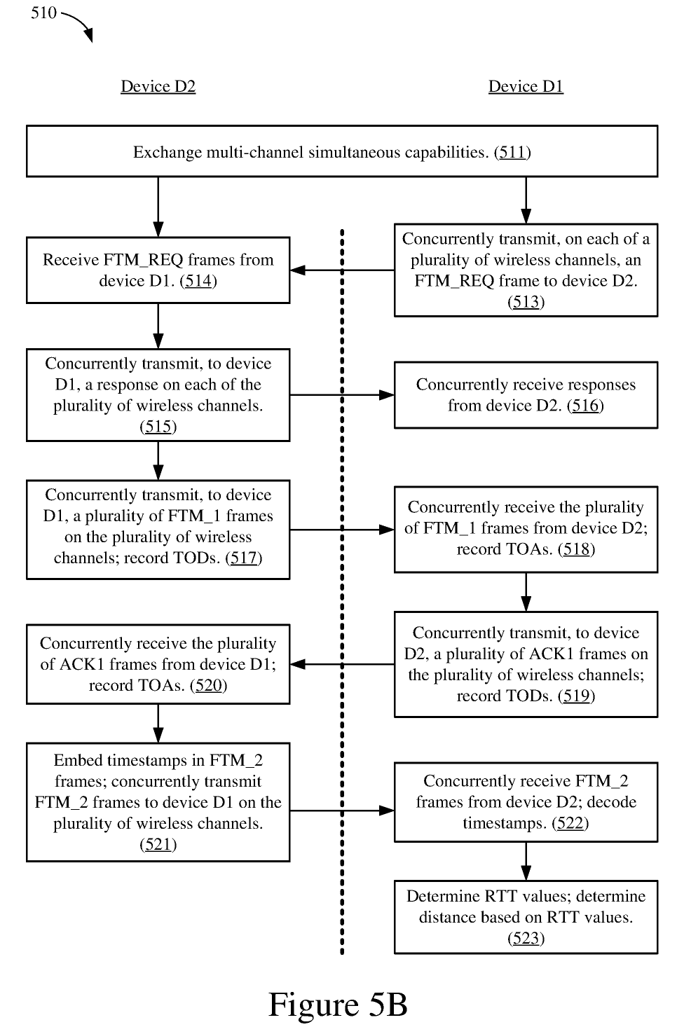

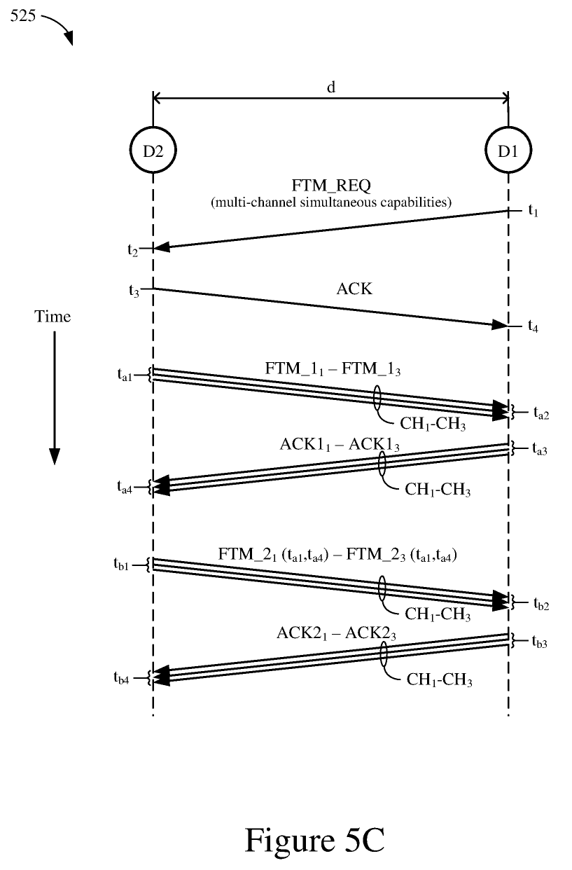

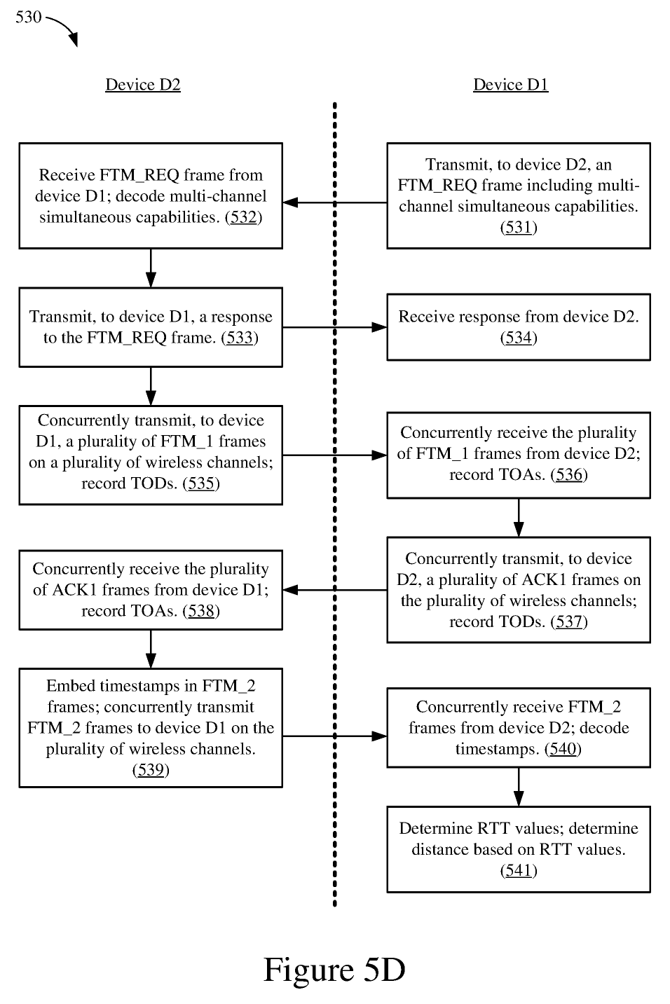

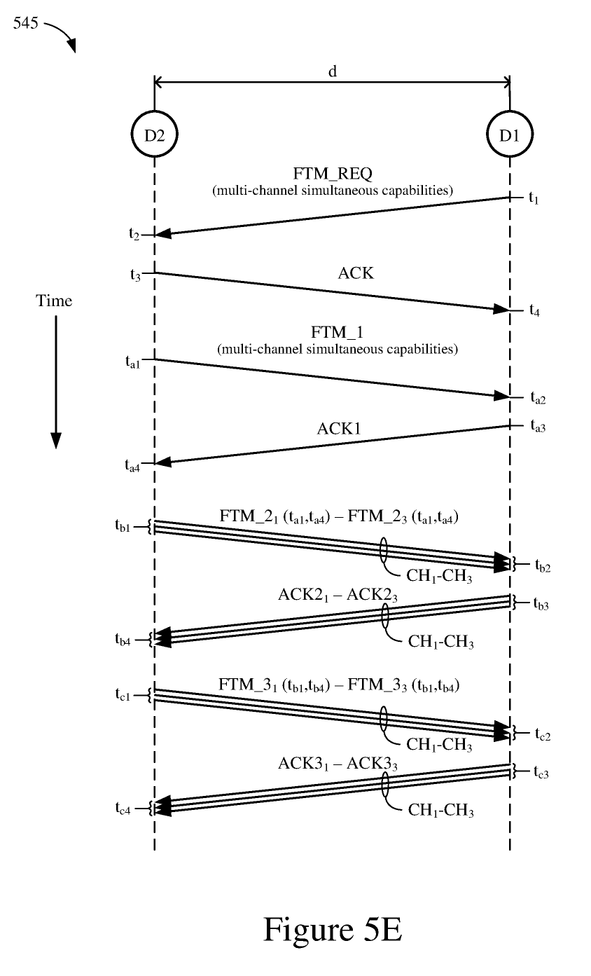

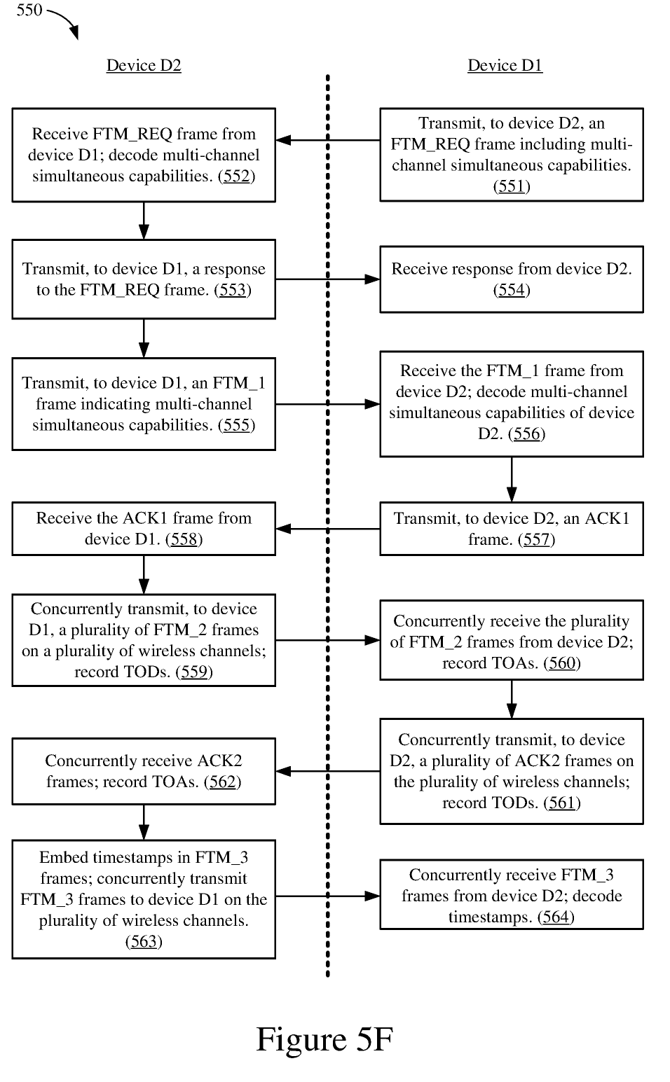

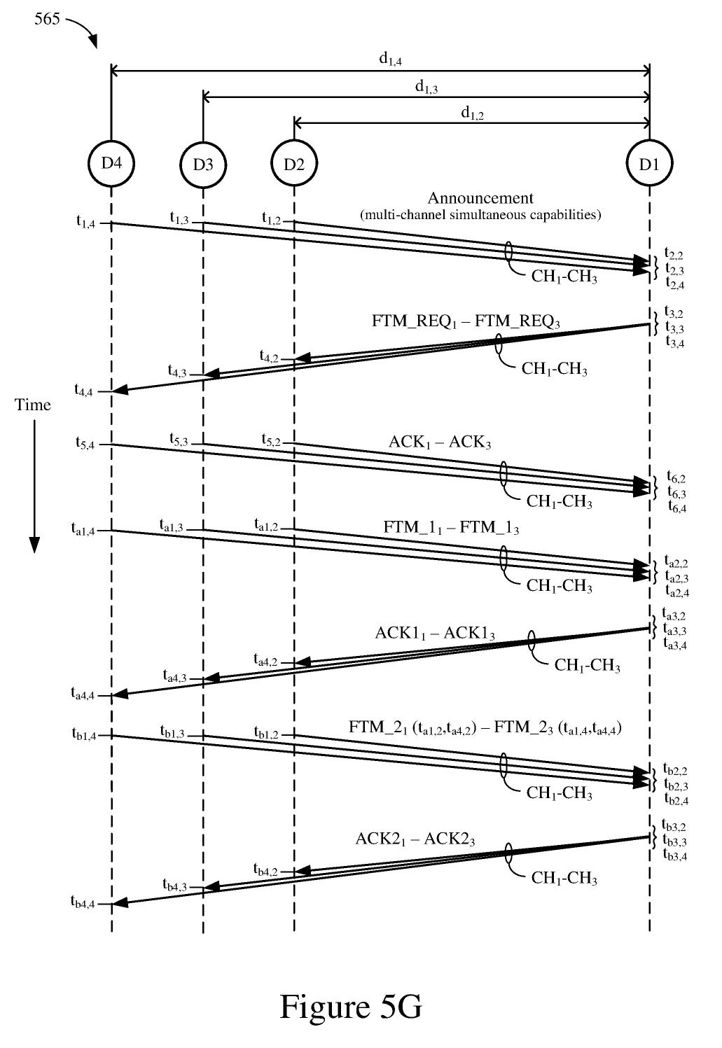

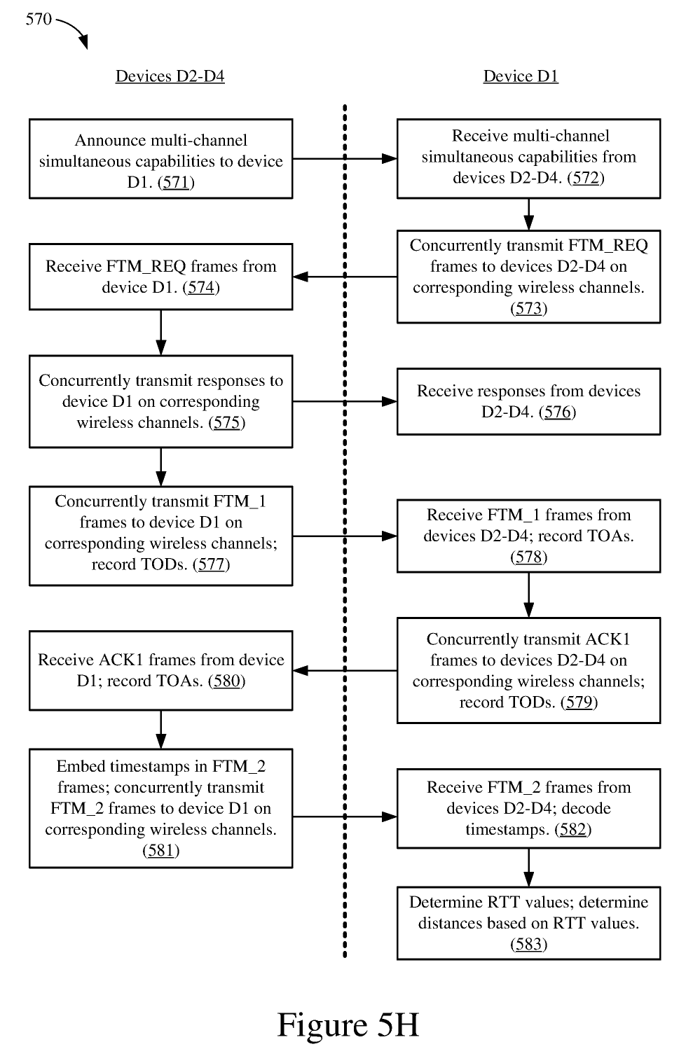

Each of stations STA1-STA4 may be any suitable Wi-Fi enabled wireless device including, for example, a cell phone, personal digital assistant (PDA), tablet device, laptop computer, or the like. Each of stations STA1-STA4 also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, each of stations STA1-STA4 may include one or more transceivers, one or more processing resources (such as processors and ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described with respect to FIGS. 5A-5H and FIGS. 9-10.

The AP 110 may be any suitable device that allows one or more wireless devices to connect to a network (such as a local area network (LAN), wide area network (WAN), metropolitan area network (MAN), and the Internet) via AP 110 using Wi-Fi, Bluetooth, or any other suitable wireless communication standards. For at least some implementations, AP 110 may include one or more transceivers, one or more processing resources (such as processors and ASICs), one or more memory resources, and a power source. The memory resources may include a non-transitory computer-readable medium (such as one or more nonvolatile memory elements, such as EPROM, EEPROM, Flash memory, a hard drive, etc.) that stores instructions for performing operations described with respect to FIGS. 5A-5H and FIGS. 9-10.

For the stations STA1-STA4 and AP 110, the one or more transceivers may include Wi-Fi transceivers, Bluetooth transceivers, cellular transceivers, and other suitable radio frequency (RF) transceivers (not shown for simplicity) to transmit and receive wireless communication signals. Each transceiver may communicate with other wireless devices in distinct operating frequency bands and using distinct communication protocols. For example, the Wi-Fi transceiver may communicate within a 2.4 GHz frequency band, within a 5 GHz frequency band in accordance with the IEEE 802.11 specification, and within a 60 GHz frequency band. The cellular transceiver may communicate within various RF frequency bands in accordance with a 4G Long Term Evolution (LTE) protocol described by the 3rd Generation Partnership Project (3GPP) (such as between approximately 700 MHz and approximately 3.9 GHz) and in accordance with other cellular protocols (such as a Global System for Mobile (GSM) communications protocol). In other implementations, the transceivers included within each of the stations STA1-STA4 may be any technically feasible transceiver such as a ZigBee transceiver described by a specification from the ZigBee specification, a WiGig transceiver, and a HomePlug transceiver described a specification from the HomePlug Alliance.

For at least some implementations, each of the stations STA1-STA4 and AP 110 may include radio frequency (RF) ranging circuitry (such as formed using well-known software modules, hardware components, or a suitable combination thereof) that may be used to estimate the distance between itself and another Wi-Fi enabled device and to determine the location of itself, relative to one or more other wireless devices, using ranging techniques described herein. In addition, each of the stations STA1-STA4 and AP 110 may include a local memory (not shown in FIG. 1 for simplicity) to store a cache of Wi-Fi access point and station data.

Further, for some implementations, ranging operations described herein may be performed without using the AP 110, for example, by having a number of the stations operating in an ad-hoc or peer-to-peer mode, thereby allowing the stations to range one another even when outside the reception range of AP 110 or a visible WLAN (or other wireless network). In addition, the ranging operations described herein may be performed between two APs that are in wireless range of each other.

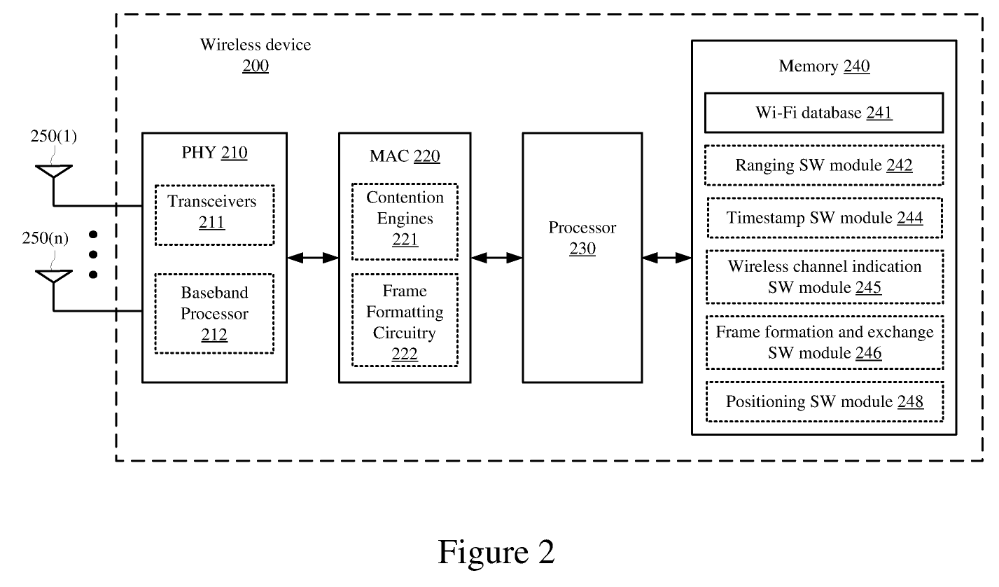

FIG. 2 is a block diagram of an example wireless device 200. The wireless device 200 may be one implementation of the stations STA1-STA4 and AP 110 of FIG. 1. The wireless device 200 may include a PHY device 210 including at least a number of transceivers 211 and a baseband processor 212, may include a MAC 220 including at least a number of contention engines 221 and frame formatting circuitry 222, may include a processor 230, may include a memory 240, and may include a number of antennas 250(1)-250(n). The transceivers 211 may be coupled to antennas 250(1)-250(n), either directly or through an antenna selection circuit (not shown for simplicity). The transceivers 211 may be used to transmit signals to and receive signals from AP 110, other stations, and other suitable wireless devices (see also FIG. 1), and may be used to scan the surrounding environment to detect and identify nearby access points and other wireless devices (such as within wireless range of wireless device 200). Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, for some implementations, the wireless device 200 may be configured for MIMO operations. The MIMO operations may include SU-MIMO operations and MU-MIMO operations. In addition, the multiple transmit and receive chains provided within transceivers 211 may allow wireless device 200 to facilitate SBS and DBS operations, for example, so that wireless device 200 may simultaneously exchange a plurality of sets of ranging frames with one or more other devices using a plurality of different wireless channels.

The baseband processor 212 may be used to process signals received from processor 230 and memory 240 and to forward the processed signals to transceivers 211 for transmission via one or more of antennas 250(1)-250(n), and may be used to process signals received from one or more of antennas 250(1)-250(n) via transceivers 211 and to forward the processed signals to processor 230 and memory 240.

For purposes of discussion herein, MAC 220 is shown in FIG. 2 as being coupled between PHY device 210 and processor 230. For actual implementations, PHY device 210, MAC 220, processor 230, and memory 240 may be connected together using one or more buses (not shown for simplicity).

The contention engines 221 may contend for access to one or more shared wireless mediums, and also may store packets for transmission over the one or more shared wireless mediums. For other implementations, the contention engines 221 may be separate from MAC 220. For still other implementations, the contention engines 221 may be implemented as one or more software modules (such as stored in memory 240 or stored in memory provided within MAC 220) containing instructions that, when executed by processor 230, perform the functions of contention engines 221.

The frame formatting circuitry 222 may be used to create and format frames received from processor 230 and memory 240 (such as by adding MAC headers to PDUs provided by processor 230), and may be used to re-format frames received from PHY device 210 (such as by stripping MAC headers from frames received from PHY device 210).

Memory 240 may include a Wi-Fi database 241 that may store location data, configuration information, data rates, MAC addresses, and other suitable information about (or pertaining to) a number of access points, stations, and other wireless devices. The Wi-Fi database 241 also may store profile information for a number of wireless devices. The profile information for a given wireless device may include information such as the wireless device's service set identification (SSID), channel information, received signal strength indicator (RSSI) values, goodput values, channel state information (CSI), and connection history with wireless device 200.

Memory 240 also may include a non-transitory computer-readable medium (such as one or more nonvolatile memory elements, such as EPROM, EEPROM, Flash memory, a hard drive, and so on) that may store the following software (SW) modules:
a ranging SW module 242 to determine RTT values and to estimate the distance between wireless device 200 and one or more other devices, for example, as described for one or more operations of FIGS. 5A-5H and FIGS. 9-10;
a timestamp SW module 244 to capture timestamps of signals received by wireless device 200 (such as time of arrival (TOA) information) and to capture timestamps of signals transmitted from wireless device 200 (such as time of departure (TOD) information), for example, as described for one or more operations of FIGS. 5A-5H and FIGS. 9-10;
a wireless channel indication SW module 245 to select, determine, and indicate a plurality of wireless channels that may be used for ranging operations with one or more other wireless devices and to announce channel information pertaining to each of the indicated wireless channels to other wireless devices, for example, as described for one or more operations of FIGS. 5A-5H and FIGS. 9-10;
a frame formation and exchange SW module 246 to create, transmit, and receive frames to and from other wireless devices, to embed multi-channel simultaneous capability information into frames transmitted to other wireless devices, and to decode multi-channel simultaneous capability information received from other wireless devices, for example, as described for one or more operations of FIGS. 5A-5H and FIGS. 9-10; and
a positioning SW module 248 to determine the location of wireless device 200 based, at least in part, on the distances determined by the ranging SW module 242, for example, as described for one or more operations of FIGS. 5A-5H and FIGS. 9-10.
   Each software module includes instructions that, when executed by processor 230, cause the wireless device 200 to perform the corresponding functions. The non-transitory computer-readable medium of memory 240 thus includes instructions for performing all or a portion of the operations of FIGS. 5A-5H and FIGS. 9-10.

The processor 230, which is coupled to MAC 220 and memory 240, may be one or more suitable processors capable of executing scripts or instructions of one or more software programs stored in wireless device 200 (such as within memory 240). For example, processor 230 may execute the ranging SW module 242 to determine RTT values and to estimate the distance between wireless device 200 and one or more other devices based on a number of ranging frames exchanged between wireless device 200 and each of the one or more other wireless devices.

The processor 230 may execute the timestamp SW module 244 to capture timestamps of signals received by wireless device 200 (such as TOA information) and to capture timestamps of signals transmitted from wireless device 200 (such as TOD information). For example, the timestamp SW module 244 may be executed to capture TOA information of FTM frames, TOA information of ACK frames, TOD information of FTM frames, and TOD information of ACK frames.

The processor 230 may execute the wireless channel indication SW module 245 to select, determine, and indicate a plurality of wireless channels that may be used for ranging operations with one or more other wireless devices and to announce channel information pertaining to each of the indicated wireless channels to other wireless devices. In some implementations, the wireless channel indication SW module 245 may be executed to announce the multi-channel simultaneous capabilities of wireless device 200, to announce channel information pertaining to the plurality of indicated wireless channels, and to decode the multi-channel simultaneous capabilities of other wireless devices. The multi-channel simultaneous capabilities may indicate whether wireless device 200 is capable of SBS operations and DBS operations. In some aspects, the channel information may include at least a frequency band, a channel number, and a channel bandwidth of each of the indicated wireless channels.

The processor 230 may execute the frame formation and exchange SW module 246 to create, transmit, and receive frames to and from other wireless devices, to embed capability information into frames transmitted to other wireless devices, and to decode capability information received from other wireless devices. The frames created, transmitted, and received by execution of the frame formation and exchange SW module 246 may be any suitable frames including, for example, action frames, control frames, management frames, and data frames. The management frames may include any suitable type of FTM frames (such as FTM request frames and FTM ranging frames), any suitable type of beacon frames, any suitable type of probe request and probe response frames, any suitable type of association request and association response frames, and any suitable type of ACK frames.

The processor 230 may execute the positioning SW module 248 to determine the location of wireless device 200 based, at least in part, on the distances determined by the ranging SW module 242. For example, the positioning SW module 248 may be executed to determine the relative position of wireless device 200 from the distances between wireless device 200 and three other devices (such as using known trilateration techniques). If the locations of the three other devices are known, then the actual position of wireless device 200 may be determined.

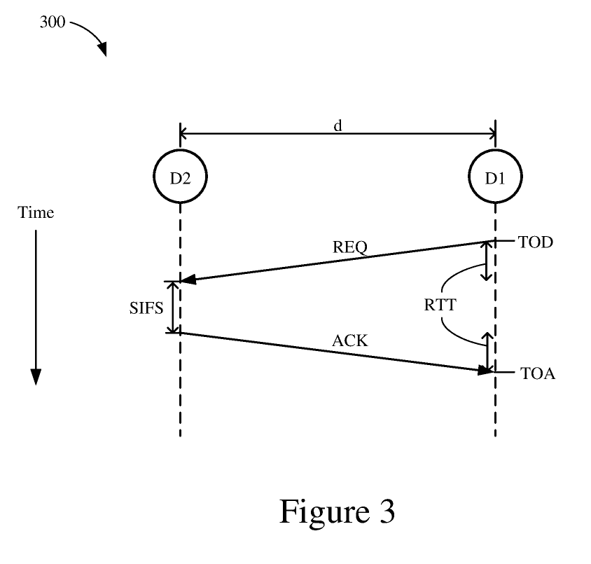

The distance between a pair of devices may be determined using the RTT of signals exchanged between the devices. FIG. 3 is a signal diagram of an example ranging operation 300. The example ranging operation 300 is performed between a first device D1 and a second device D2. The distance (d) between the first device D1 and the second device D2 may be estimated as d=c*RTT/2, where c is the speed of light, and RTT is the summation of the actual signal propagation times of a request (REQ) frame and an acknowledgement (ACK) frame exchanged between device D1 and device D2. Device D1 and device D2 may each be, for example, an access point (such as AP 110 of FIG. 1), a station (such as one of stations STA1-STA4 of FIG. 1), or another suitable wireless device (such as the wireless device 200 of FIG. 2).

More specifically, the device D1 may estimate the RTT between itself and device D2 using the time of departure (TOD) of the REQ frame transmitted from device D1, the time of arrival (TOA) of the ACK frame received by device D1, and the short interframe space (SIFS) duration of device D2. The SIFS duration may indicate the duration of time between device D2 receiving the REQ frame and transmitting the ACK frame. The SIFS duration, a range of values for which are provided by the IEEE 802.11 standards, provides Wi-Fi enabled devices time to switch their transceivers from a receive mode (such as to receive the REQ frame) to a transmit mode (such as to transmit the ACK frame).

Because different make-and-models (and sometimes even same make-and-models) of communication devices have different processing delays, the precise value of SIFS may vary between devices (and even between successive frame receptions/transmissions in the same device). As a result, the value of SIFS is typically estimated, which often leads to errors in estimating the distance between two devices. More specifically, the IEEE 802.11 standards define the SIFS duration as 10 us+/−900 ns at 2.4 GHz, 16 us+/−900 ns at 5 GHz, and 3 us+/−900 ns at 60 GHz. These “standard” SIFS durations include tolerances that may decrease the accuracy of RTT estimates. For example, even if the SIFS duration of de vice D2 may be estimated within +/−25 ns, a ranging error of +/−7.5 meters may result (which may be unacceptable for many positioning systems).

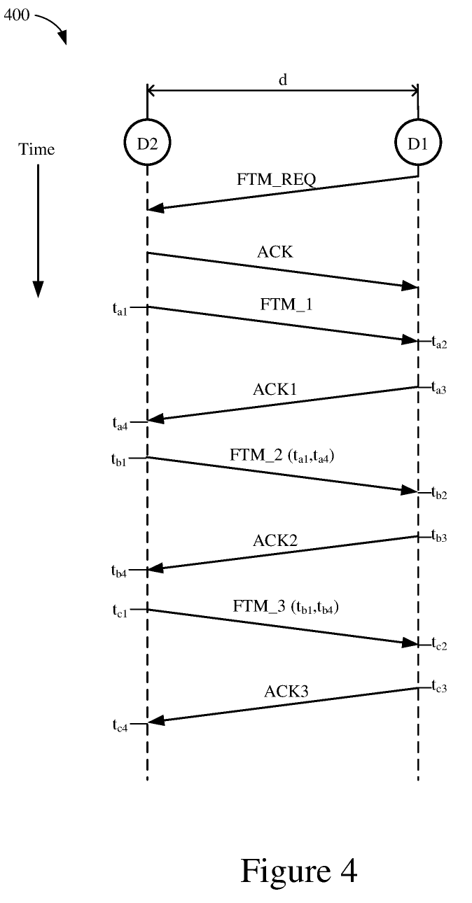

To reduce ranging errors resulting from uncertainties in the value of SIFS, recent revisions to the IEEE 802.11 standards call for each ranging device to capture timestamps of incoming and outgoing frames so that the value of RTT may be determined without using SIFS. FIG. 4 is a signal diagram of another example ranging operation 400. The example ranging operation 400 is performed between device D1 and device D2 performed using Fine Timing Measurement (FTM) frames in accordance with the IEEE 802.11REVmc standards. Device D1 and device D2 may each be, for example, an access point (such as AP 110 of FIG. 1), a station (such as one of stations STA1-STA4 of FIG. 1), or other suitable wireless device (such as wireless device 200 of FIG. 2). For the example of FIG. 4, device D1 requests the ranging operation; thus, device D1 is the initiator device (or alternatively the requestor device) and device D2 is the responder device. Note that the term “initiator device” also may refer to an initiator STA, and the term “responder device” also may refer to a responder STA.

Device D1 may request or initiate the ranging operation by transmitting an FTM request (FTM_REQ) frame to device D2. The FTM_REQ frame also may include a request for device D2 to capture timestamps (such as TOA information) of frames received by device D2 and to capture timestamps (such as TOD information) of frames transmitted from device D2. Device D2 receives the FTM_REQ frame, and may acknowledge the requested ranging operation by transmitting an acknowledgement (ACK) frame to device D1. The ACK frame may indicate whether device D2 is capable of capturing the requested timestamps. It is noted that the exchange of the FTM_REQ frame and the ACK frame is a handshake process that not only signals an intent to perform a ranging operation but also allows devices D1 and D2 to determine whether each other supports capturing timestamps.

At time tₐ₁, device D2 transmits a first FTM (FTM_1) frame to device D1, and may capture the TOD of the FTM_1 frame as time tₐ₁. Device D1 receives the FTM_1 frame at time tₐ₂, and may capture the TOA of the FTM_1 frame as time tₐ₂. Device D1 responds by transmitting a first FTM acknowledgement (ACK1) frame to device D2 at time tₐ₃, and may capture the TOD of the ACK1 frame as time tₐ₃. Device D2 receives the ACK1 frame at time tₐ₄, and may capture the TOA of the ACK1 frame at time tₐ₄. At time t_{b1}, device D2 transmits to device D1 a second FTM (FTM_2) frame that includes the timestamps captured at times tₐ₁ and tₐ₄ (such as the TOD of the FTM_1 frame and the TOA of the ACK1 frame). Device D1 receives the FTM_2 frame at time t_{b2}, and may capture its timestamp as time t_{b2}.

Upon receiving the FTM_2 frame at time t_{b2}, device D1 has timestamp values for times tₐ₁, tₐ₂, tₐ₃, and tₐ₄ that correspond to the TOD of the FTM_1 frame transmitted from device D2, the TOA of the FTM_1 frame at device D1, the TOD of the ACK1 frame transmitted from device D1, and the TOA of the ACK1 frame at device D2, respectively. Thereafter, device D1 may determine a first RTT value as RTT₁=(tₐ₄−tₐ₃)+(tₐ₂−tₐ₁). Because the value of RTT₁ does not involve estimating SIFS for either device D1 or device D2, the value of RTT₁ does not involve errors resulting from uncertainties of SIFS durations. Consequently, the accuracy of the resulting estimate of the distance between devices D1 and D2 is improved (such as compared to the ranging operation 300 of FIG. 3).

As depicted in FIG. 4, devices D1 and D2 are shown to exchange an additional pair of FTM and ACK frames from which an additional RTT value may be determined. Specifically, at time t_{b3}, device D1 may transmit a second FTM acknowledgement (ACK2) frame to device D2 (such as to acknowledge reception of the FTM_2 frame). Device D2 receives the ACK2 frame at time t_{b4}, and may record the TOA of the ACK2 frame as time t_{b4}. At time t_{c1}, device D2 transmits to device D1 a third FTM (FTM_3) frame that includes the timestamps captured at times t_{b1} and t_{b4} (such as the TOD of the FTM_2 frame and the TOA of the ACK2 frame). Device D1 receives the FTM_3 frame at time t_{c2}, and may capture its timestamp as time t_{c2}. Device D1 may respond by transmitting a third FTM acknowledgement (ACK3) frame to device D2 at time t_{c3}.

Upon receiving the FTM_3 frame at time t_{c2}, device D1 has timestamp values for times t_{b1}, t_{b2}, t_{b3}, and t_{b4} that correspond to the TOD of the FTM_2 frame transmitted from device D2, the TOA of the FTM_2 frame at device D1, the TOD of the ACK2 frame transmitted from device D1, and the TOA of the ACK2 frame at device D2, respectively. Thereafter, device D1 may determine a second RTT value as RTT₂=(t_{b4}−t_{b3})+(t_{b2}−t_{b1}). This process may continue for any number of subsequent FTM and ACK frame exchanges between devices D1 and D2, for example, where device D2 embeds the timestamps of a given FTM and ACK frame exchange into a subsequent FTM frame transmitted to device D1.

More specifically, by determining multiple RTT values between devices D1 and D2, ranging accuracy may be improved by using the multiple RTT values to average out noise and to eliminate outlier RTT values (such as RTT values that are more than a given deviation from an average RTT value between devices D1 and D2). Although ranging accuracy may improve as the number of FTM and ACK frame exchanges increases, the time duration of the ranging operation also increases, which may be undesirable.

FIG. 5A is a signal diagram of an example ranging operation 500, and FIG. 5B is a sequence diagram 510 depicting the example ranging operation of FIG. 5A. The example ranging operation 500 is performed between a first device D1 and a second device D2. Device D1 and device D2 may each be, for example, an access point (such as AP 110 of FIG. 1), a station (such as one of stations STA1-STA4 of FIG. 1), or another suitable wireless device (such as wireless device 200 of FIG. 2). As described in more detail, the example ranging operation 500 of FIG. 5A may allow device D1 and device D2 to simultaneously (or substantially simultaneously) exchange a plurality of sets of FTM and ACK frames on a corresponding plurality of different wireless channels, thereby allowing device D1 to simultaneously determine a plurality of RTT values indicative of the distance (d) between devices D1 and D2. The plurality of RTT values be may combined (such as averaged) to offset noise and erroneous RTT values, for example, to increase ranging accuracy. For one example, each set of ranging frames can be exchanged simultaneously when all transceiver chains of the wireless device are substantially synchronized with each other and when all transceiver chains of the receiving device are substantially synchronized with each other. For another example, each set of ranging frames can be exchanged substantially simultaneously (such as on the order of tens of milliseconds or less of each other) when there is a timing mismatch or phase offset between the transceiver chains of the wireless device or when there is a timing mismatch or phase offset between the transceiver chains of the receiving device.

At time t₁ or between times t₁ and t₂, device D1 and device D2 may exchange multi-channel simultaneous capabilities (511). The multi-channel simultaneous capabilities may indicate, for example, whether device D1 and device D2 is capable of SBS and DBS operations, how many wireless channels upon which device D1 and device D2 is capable of simultaneous operations, and channel information for a corresponding plurality of wireless channels. More specifically, in some implementations, one or both of devices D1 and D2 may transmit an announcement frame containing a multi-channel simultaneous capability information element (IE) that indicates a plurality of wireless channels that may be used for the ranging operation and may include channel information for each of the indicated wireless channels. The channel information may indicate a channel number of each of the indicated wireless channels, a frequency band of each of the indicated wireless channels, a channel bandwidth of each of the indicated wireless channels, and a number of BSSID values. In some aspects, the multi-channel simultaneous capability IE may be a vendor-specific information element (VSIE).

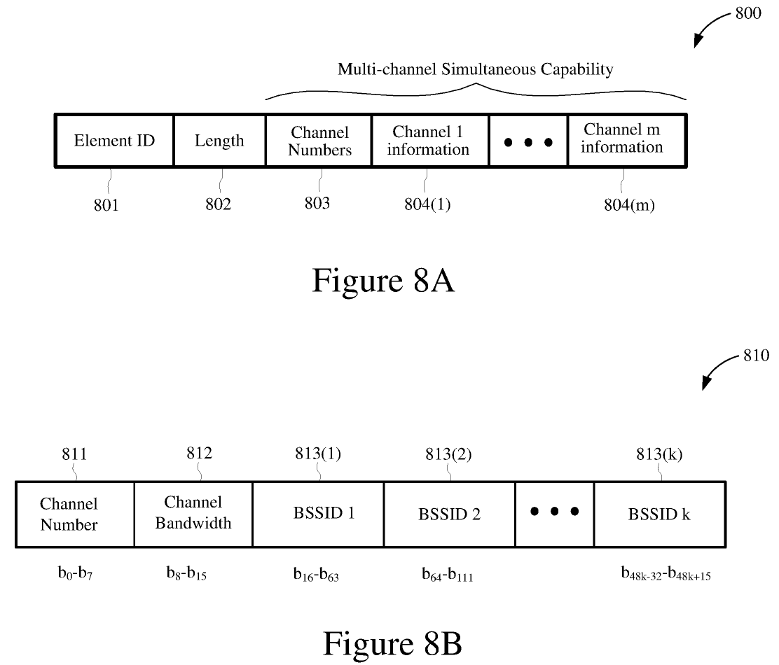

In some aspects, the channel number may be one of channels 1-14 in the 2.4 GHz frequency band or one of channels 36-165 in the 5 GHz frequency band. In some other aspects, other channels in other frequency bands may be indicated. Further, in some aspects, the channel bandwidth may be one of a 20 MHz channel, a 40 MHz channel, an 80 MHz channel, an 80+80 MHz channel, or a 160 MHz channel. In some other aspects, other channel bandwidths may be indicated. These and other details of the multi-channel simultaneous capability IE are more fully described with respect to FIGS. 8A and 8B.

In some implementations, device D1 and device D2 may each transmit a frame (such as denoted herein as an announcement frame) that includes a multi-channel simultaneous capability IE. For implementations in which device D2 is an access point or a group owner (GO), device D2 may embed or append the multi-channel simultaneous capability IE in a beacon frame, for example, so that device D1 is informed of the wireless channels upon which device D2 (as an AP) operates. For implementations in which device D1 is a station, device D1 may transmit a probe request or an association request (or any other suitable frame) to device D2, for example, to elicit a response from device D2 that includes device D2's multi-channel simultaneous capabilities. In response thereto, device D2 may embed or append the multi-channel simultaneous capability IE into a probe response or an association response, respectively. In some aspects, device D1 may transmit an Access Network Query Protocol (ANQP) query request to device D2, and device D2 may respond by transmitting, to device D1, an ANQP query response that contains the multi-channel simultaneous capability IE.

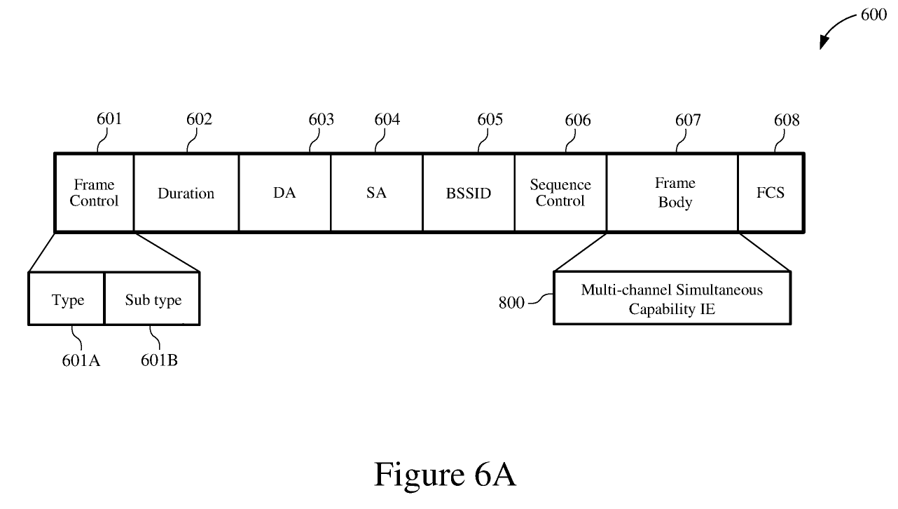

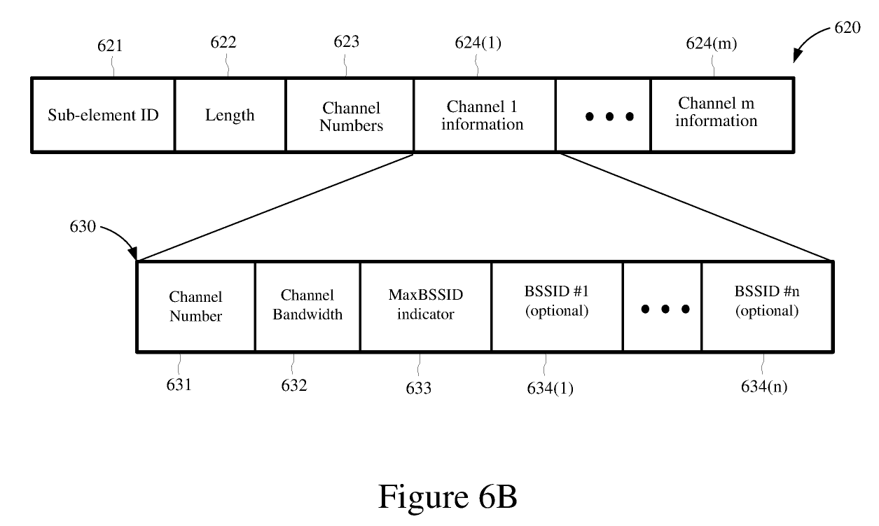

Thus, for the example ranging operation 500 depicted in FIG. 5A, the exchange of multi-channel simultaneous capabilities may be an exchange of announcement frames, may be a beacon frame transmitted from device D2 to device D1, may be an ANQP query-response transmitted from device D2 to device D1, may be a probe response transmitted from device D2 to device D1, may be an association response transmitted from device D2 to device D1, or any other suitable type of frame that may be transmitted to device D1 or exchanged between devices D1 and D2. The multi-channel simultaneous capability IE may be embedded within or appended to a beacon frame, a probe response, and an association response in any suitable manner, for example, as described in more detail with respect to FIG. 6A.

At time t₃, device D1 may concurrently (or substantially concurrently) transmit, on each of the plurality of wireless channels, an FTM_REQ frame to device D2 (513). Each of the plurality of FTM_REQ frames may request device D2 to perform the example ranging operation 500 on a corresponding one of the plurality of wireless channels. One or more of the FTM_REQ frames also may request device D2 to indicate whether it supports capturing timestamps and to indicate other capabilities. For the example ranging operation 500 of FIG. 5A, device D1 is depicted as transmitting three FTM_REQ frames (FTM_REQ₁-FTM_REQ₃) on three different wireless channels (CH₁-CH₃), respectively. In some implementations, device D1 may concurrently (or substantially concurrently) transmit other suitable numbers of FTM_REQ frames on a corresponding number of different wireless channels.

At time t₄, device D2 may concurrently (or substantially concurrently) receive the plurality of FTM_REQ frames transmitted from device D1 on the plurality of wireless channels CH₁-CH₃ (514). In response thereto, device D2 may concurrently (or substantially concurrently) transmit, on each of the plurality of wireless channels, a corresponding ACK frame to device D1 at time t₅ (such as to acknowledge receipt of the FTM_REQ frames) (515). For example, as depicted in FIG. 5A, device D2 may concurrently (or substantially concurrently) transmit ACK₁-ACK₃ frames to device D1 on wireless channels CH₁-CH₃, respectively. At time t₆, device D1 may concurrently (or substantially concurrently) receive the plurality of ACK frames (such as ACK₁-ACK₃) from device D2 (516).

Thereafter, device D2 may initiate a concurrent (or substantially concurrent) exchange of a plurality of sets of FTM and ACK frames with device D1 on the plurality of wireless channels. More specifically, at time tₐ₁, device D2 may concurrently (or substantially concurrently) transmit a plurality of FTM_1 frames to device D1 on respective ones of the plurality of wireless channels, and may record the TOD of each of the FTM_1 frames (517). For example, as depicted in FIG. 5A, device D2 may transmit an FTM_1₁ frame to device D1 on wireless channel CH₁, may transmit an FTM_1₂ frame to device D1 on wireless channel CH₂, and may transmit an FTM_1₃ frame to device D1 on wireless channel CH₃, concurrently (or substantially concurrently). At time tₐ₂, device D1 may concurrently (or substantially concurrently) receive the plurality of FTM_1 frames transmitted from device D2 on wireless channels CH₁-CH₃, and may record the TOA of each of the received FTM_1 frames (518).

At time tₐ₃, device D1 may concurrently (or substantially concurrently) transmit a plurality of first FTM acknowledgement (ACK1) frames to device D2 on respective ones of the plurality of wireless channels, and may record the TOD of each of the transmitted ACK1 frames (519). For example, as depicted in FIG. 5A, device D1 may transmit an ACK1₁ frame to device D2 on wireless channel CH₁, may transmit an ACK12 frame to device D2 on wireless channel CH₂, and may transmit an ACK13 frame to device D2 on wireless channel CH₃, concurrently (or substantially concurrently). At time tₐ₄, device D2 may concurrently (or substantially concurrently) receive the plurality of ACK1 frames from device D1, and may record the TOA of each of the ACK1 frames (520).

Device D2 may embed timestamps in each of a plurality of FTM_2 frames, may concurrently (or substantially concurrently) transmit the plurality of FTM_2 frames to device D1 on respective ones of the plurality of wireless channels at time t_{b1}, and may record the TOD of each of the FTM_2 frames (521). For example, as depicted in FIG. 5A, device D2 may transmit an FTM_2₁ frame to device D1 on wireless channel CH₁, may transmit an FTM_2₂ frame to device D1 on wireless channel CH₂, and may transmit an FTM_2₃ frame to device D1 on wireless channel CH₃, concurrently (or substantially concurrently). For the example implementation of FIG. 5A, device D2 may embed the TOD of the FTM_1₁ frame and the TOA of the ACK1₁ frame into the FTM_2₁ frame, may embed the TOD of the FTM_1₂ frame and the TOA of the ACK1₂ frame into the FTM_2₂ frame, and may embed the TOD of the FTM_1₃ frame and the TOA of the ACK1₃ frame into the FTM_2₃ frame. For other implementations, device D2 may instead embed a difference time value (such as tᵥₐₗᵤₑ=tₐ₄−tₐ₁) into each of the FTM_2 frames (such as rather than the individual TOD and TOA timestamps).

At time t_{b2}, device D1 may concurrently (or substantially concurrently) receive the plurality of FTM_2 frames, and may decode the embedded timestamps in each of the received FTM_2 frames (522). Upon receiving the FTM_2 frames at time t_{b2}, device D1 has timestamp values for times tₐ₁, tₐ₂, tₐ₃, and tₐ₄ that correspond to the TOD of each of the plurality of FTM_1 frames transmitted from device D2, the TOA of each of the plurality of FTM_1 frames received at device D1, the TOD of each of the plurality of ACK1 frames transmitted from device D1, and the TOA of each of the plurality of ACK1 frames received at device D2, respectively. Thereafter, device D1 may determine an RTT value for each of the plurality of sets of FTM and ACK frame exchanges, and may then determine the distance between device D1 and device D2 based on the plurality of RTT values (523). In some aspects, device D1 may determine each RTT value using the expression RTT=(tₐ₄−tₐ₃)+(tₐ₂−tₐ₁) for a corresponding set of FTM and ACK frames exchanged between devices D1 and D2.

More specifically, for the example of FIG. 5A, device D1 may determine three RTT values based on the three sets of FTM and ACK frame exchanges between device D1 and device D2 on the wireless channels CH₁-CH₃, respectively. For example, device D1 may determine a first RTT value (RTT₁) based on the timestamps tₐ₁, tₐ₂, tₐ₃, and tₐ₄ of the FTM_1₁ and ACK1₁ frame exchange on channel CH₁, may determine a second RTT value (RTT₂) based on the timestamps tₐ₁, tₐ₂, tₐ₃, and tₐ₄ of the FTM_1₂ and ACK1₂ frame exchange on channel CH₂, and determine a third RTT value (RTT₃) based on the timestamps tₐ₁, tₐ₂, tₐ₃, and tₐ₄ of the FTM_1₃ and ACK1₃ frame exchange on channel CH₃.

In some other implementations, device D1 may transmit the plurality of FTM_REQ frames to device D2 at the same or similar time, device D2 may transmit the plurality of ACK frames to device D1 at the same or similar time, device D2 may transmit the plurality of FTM_1 frames to device D1 at the same or similar time, device D1 may transmit the plurality of ACK1 frames to device D2 at the same or similar time, device D2 may transmit the plurality of FTM_2 frames to device D1 at the same or similar time, and device D1 may transmit the plurality of ACK2 frames to device D2 at the same or similar time.

As mentioned above, ranging accuracy may improve as the number of FTM and ACK frame exchanges increases. Thus, by estimating the distance between devices D1 and D2 using three RTT values determined from three sets of concurrent (or substantially concurrent) FTM and ACK frame exchanges, the example ranging operation 500 depicted in FIG. 5A may achieve greater accuracy (such as compared with the example ranging operation of FIG. 4) in a similar time period.

It is noted that although each of the times t₁-t₆, tₐ₁-tₐ₄, and t_{b1}-t_{b4} is depicted as a single time in the example of FIG. 5A, each of the times t₁-t₆, tₐ₁-tₐ₄, and t_{b1}-t_{b4} may represent three slightly different times, for example, due to the orientation of device D1's antennas, the orientation of device D2's antennas, multipath effects, the availability of channels CH₁-CH₃, and other factors. For example, although the FTM_1₁-FTM_1₃ frames are depicted in FIG. 5A as departing from device D2 at the same time (tₐ₁), the TODs of the FTM_1₁-FTM_1₃ frames may be slightly different. Similarly, although the FTM_1₁-FTM_1₃ frames are depicted in FIG. 5A as arriving at device D1 at the same time (tₐ₂), the TOAs of the FTM_1₁-FTM_1₃ frames at device D1 may be slightly different. The same is true for the TODs of the ACK₁-ACK₃ frames from device D1 (time tₐ₃), the TOAs of the ACK₁-ACK₃ frames at device D2 (time tₐ₄), the TODs of the FTM_2₁-FTM_2₃ frames from device D2 (time t_{b1}), and the TOAs of the FTM_2₁-FTM_2₃ frames at device D1 (time t_{b2}).

FIG. 5C is a signal diagram of another example ranging operation 525, and FIG. 5D is a sequence diagram 530 depicting the example ranging operation 525 of FIG. 5C. The example ranging operation 525 is performed between device D1 and device D2. Device D1 and device D2 may each be, for example, an access point (such as AP 110 of FIG. 1), a station (such as one of stations STA1-STA4 of FIG. 1), or another suitable wireless device (such as wireless device 200 of FIG. 2).

The example ranging operation 525 of FIG. 5C is similar to the example ranging operation 500 of FIG. 5A, except that device D1 may indicate its simultaneous multi-channel capabilities in the FTM_REQ frame. Device D2 may decode the simultaneous multi-channel capabilities of device D1, acknowledge receipt of the FTM_REQ frame, and then initiate a concurrent (or substantially concurrent) exchange of a plurality of sets of FTM and ACK frames. Thus, device D2 may not need to transmit a beacon frame including the multi-channel simultaneous capability IE, and device D1 may not need to transmit a frame (such as a probe request, association request, or ANQP query request) prior to transmission of the FTM_REQ frame to elicit a response from device D2 that includes its multi-channel simultaneous capabilities. This may reduce the time period of ranging operation 525 (such as compared to the example ranging operation 500 of FIG. 5A). However, because device D2 may not be aware of device D1's simultaneous multi-channel capabilities, device D1 may transmit the FTM_REQ frame on a single channel (such as the channel upon which devices D1 and D2 may be associated with an access point if both devices D1 and D2 are stations or the channel upon which device D1 is associated with device D2 if device D1 is a station and device D2 is an access point).

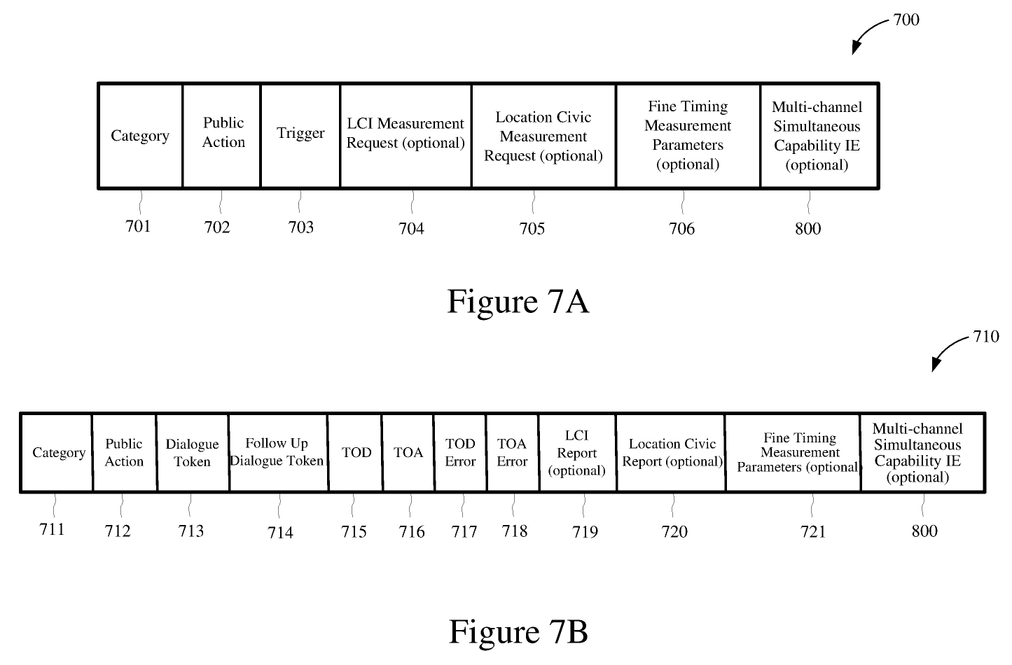

Also referring to FIG. 5C, at time t₁, device D1 may transmit, to device D2, an FTM_REQ frame announcing its multi-channel simultaneous capabilities on a single channel (531). More specifically, for some implementations, the FTM_REQ frame depicted in FIG. 5C may include the multi-channel simultaneous capability IE described above with respect to FIG. 5A. The multi-channel simultaneous capability IE may be embedded within or appended to the FTM_REQ frame in any suitable manner, for example, as described in more detail with respect to FIG. 7A.

At time t₂, device D2 receives the FTM_REQ frame (532). Device D2 may decode the multi-channel simultaneous capabilities of device D1, for example, to identify the plurality of wireless channels upon which devices D1 and D2 may simultaneously exchange sets of FTM and ACK frames.

At time t₃, device D2 may transmit a response (such as an ACK frame) to device D1 (533). Device D1 may receive the response from device D1 at time t₄ (534). In some aspects, the response may indicate whether device D2 is capable of simultaneous operations on the plurality of channels CH₁-CH₃ indicated in the multi-channel simultaneous capability IE transmitted from device D1. In some aspects, device D1 may enter a listening mode to determine whether device D2 subsequently transmits a plurality of FTM_1 frames on the plurality of wireless channels indicated in the multi-channel simultaneous capability IE. For example, device D1 may sweep or scan the wireless channels indicated in the multi-channel simultaneous capability IE to determine whether any FTM_1 frames are transmitted from device D2.

Thereafter, device D2 may initiate a concurrent (or substantially concurrent) exchange of a plurality of sets of FTM and ACK frames with device D1 on the plurality of wireless channels, for example, without transmitting its multi-channel simultaneous capabilities to device D1. More specifically, at time tₐ₁, device D2 may concurrently (or substantially concurrently) transmit a plurality of FTM_1 frames to device D1 on respective ones of the plurality of wireless channels, and may record the TOD of each of the FTM_1 frames (535). For example, as depicted in FIG. 5C, device D2 may transmit an FTM_1₁ frame to device D1 on wireless channel CH₁, may transmit an FTM_1₂ frame to device D1 on wireless channel CH₂, and may transmit an FTM_1₃ frame to device D1 on wireless channel CH₃, concurrently (or substantially concurrently). At time tₐ₂, device D1 may concurrently (or substantially concurrently) receive the plurality of FTM_1 frames transmitted from device D2 on wireless channels CH₁-CH₃, and may record the TOA of each of the received FTM_1 frames (536).

At time tₐ₃, device D1 may concurrently (or substantially concurrently) transmit a plurality of first FTM acknowledgement (ACK1) frames to device D2 on respective ones of the plurality of wireless channels, and may record the TOD of each of the transmitted ACK1 frames (537). For example, as depicted in FIG. 5C, device D1 may transmit an ACK11 frame to device D2 on wireless channel CH₁, may transmit an ACK1₂ frame to device D2 on wireless channel CH₂, and may transmit an ACK1₃ frame to device D2 on wireless channel CH₃, concurrently (or substantially concurrently). At time tₐ₄, device D2 receives the plurality of ACK1 frames from device D1, and records the TOA of each of the ACK1 frames (538).

Device D2 may embed timestamps in each of a plurality of FTM_2 frames, may concurrently (or substantially concurrently) transmit the plurality of FTM_2 frames to device D1 on respective ones of the plurality of wireless channels at time t_{b1}, and may record the TOD of each of the FTM_2 frames (539). For example, as depicted in FIG. 5C, device D2 may transmit an FTM_2₁ frame to device D1 on wireless channel CH₁, may transmit an FTM_2₂ frame to device D1 on wireless channel CH₂, and may transmit an FTM_2₃ frame to device D1 on wireless channel CH₃, concurrently (or substantially concurrently), in a manner similar to that described above with respect to FIG. 5A.

At time t_{b2}, device D1 may concurrently (or substantially concurrently) receive the plurality of FTM_2 frames, and may decode the embedded timestamps in each of the received FTM_2 frames (540). Upon receiving the FTM_2 frames at time t_{b2}, device D1 has timestamp values for times tₐ₁, tae, tₐ₃, and tₐ₄ that correspond to the TOD of each of the plurality of FTM_1 frames transmitted from device D2, the TOA of each of the plurality of FTM_1 frames received at device D1, the TOD of each of the plurality of ACK1 frames transmitted from device D1, and the TOA of each of the plurality of ACK1 frames received at device D2, respectively.

In some other implementations, device D2 may transmit the plurality of FTM_1 frames to device D1 at the same or similar time, device D1 may transmit the plurality of ACK1 frames to device D2 at the same or similar time, device D2 may transmit the plurality of FTM_2 frames to device D1 at the same or similar time, and device D1 may transmit the plurality of ACK2 frames to device D2 at the same or similar time.

Thereafter, device D1 may determine an RTT value for each of the plurality of sets of FTM and ACK frame exchanges, and may then determine the distance between device D1 and device D2 based on the plurality of RTT values (541). In some aspects, device D1 may determine each RTT value using the expression RTT=(tₐ₄−tₐ₃)+(tₐ₂−tₐ₁) for a corresponding set of FTM and ACK frames exchanged between devices D1 and D2.

It is noted that although each of the times t₁-t₄, tₐ₁-tₐ₄, and t_{b1}-t_{b4} is depicted as a single time in the example of FIG. 5C, each of the times t₁-t₄, tₐ₁-tₐ₄, and t_{b1}-t_{b4} may represent three slightly different times, for example, due to the orientation of device D1's antennas, the orientation of device D2's antennas, multipath effects, the availability of channels CH₁-CH₃, and other factors.

FIG. 5E is a signal diagram of another example ranging operation 545, and FIG. 5F is a sequence diagram 550 depicting the example ranging operation 545 of FIG. 5E. The example ranging operation 545 is performed between device D1 and device D2. Devices D1 and D2 may each be, for example, an access point (such as AP 110 of FIG. 1), a station (such as one of stations STA1-STA4 of FIG. 1), or another suitable wireless device (such as wireless device 200 of FIG. 2).

The example ranging operation 545 of FIG. 5E is similar to the example ranging operation 525 of FIG. 5C, except that in the example ranging operation 545 of FIG. 5E, device D2 transmits its multi-channel simultaneous capabilities to device D1 in the FTM_1 frame. In this manner, device D1 may be aware of the multi-channel simultaneous capabilities of device D2 prior to exchanging a plurality of sets of FTM and ACK with device D2 on a plurality of different wireless channels, albeit at the cost of an extra FTM/ACK exchange (such as compared to the example ranging operation 525 of FIG. 5C).

Also referring to FIG. 5E, at time t₁, device D1 may transmit, to device D2, an FTM_REQ frame indicating its multi-channel simultaneous capabilities (551). The FTM_REQ frame, which may be transmitted to device D1 on a single channel, may include a multi-channel simultaneous capability IE described above with respect to Figures SA and SC. At time t₂, device D2 receives the FTM_REQ frame (552). Device D2 may decode the multi-channel simultaneous capabilities of device D1. At time t₃, device D2 may transmit a response (such as an ACK frame) to device D1 on the single channel (553). Device D1 may receive the response from device D1 at time t₄ (554). Note that although the FTM_1 and ACK1 frames of FIG. 5E are exchanged on a single channel (such as rather than on the plurality of wireless channels CH₁-CH₃ in the example ranging operations 500 and 525 of Figures SA and SC, respectively), device D1 may use the FTM_1 and ACK1 frame exchange to determine an RTT value.

Then, at time tₐ₁, device D2 may transmit, to device D1, an FTM_1 frame indicating its multi-channel simultaneous capabilities (555). More specifically, the FTM_1 frame of FIG. 5E may include the multi-channel simultaneous capability IE described above with respect to FIG. 5A, thereby allowing device D1 to determine whether device D2 supports SBS and DBS operations, an indication of which (and how many) wireless channels device D2 may simultaneously use, and channel information pertaining to the indicated channels. The multi-channel simultaneous capability IE may be embedded within or appended to the FTM_1 frame in any suitable manner, for example, as described in more detail with respect to FIG. 7B.

At time tₐ₂, device D1 may receive the FTM_1 frame, and may decode the multi-channel simultaneous capabilities of device D2 (556). At time tₐ₃, device D1 may transmit, to device D2, a first FTM acknowledgement (ACK1) frame (557). Device D2 may receive the ACK1 frame at time tₐ₄ (558).

Thereafter, device D2 may initiate a concurrent (or substantially concurrent) exchange of a plurality of sets of FTM and ACK frames with device D1 on the plurality of wireless channels. More specifically, at time t_{b1}, device D2 may concurrently (or substantially concurrently) transmit a plurality of FTM_2 frames to device D1 on respective ones of the plurality of wireless channels, and may record the TOD of each of the FTM_2 frames (559). For example, as depicted in FIG. 5E, device D2 may transmit an FTM_2₁ frame to device D1 on wireless channel CH₁, may transmit an FTM_2₂ frame to device D1 on wireless channel CH₂, and may transmit an FTM_2₃ frame to device D1 on wireless channel CH₃, concurrently (or substantially concurrently). At time t_{b2}, device D1 may concurrently (or substantially concurrently) receive the plurality of FTM_2 frames transmitted from device D2 on wireless channels CH₁-CH₃, and may record the TOA of each of the received FTM_2 frames (560).

At time t_{b3}, device D1 may concurrently (or substantially concurrently) transmit a plurality of ACK2 frames to device D2 on respective ones of the plurality of wireless channels, and may record the TOD of each of the transmitted ACK2 frames (561). For example, as depicted in FIG. 5E, device D1 may transmit an ACK2₁ frame to device D2 on wireless channel CH₁, may transmit an ACK2₂ frame to device D2 on wireless channel CH₂, and may transmit an ACK2₃ frame to device D2 on wireless channel CH₃, concurrently (or substantially concurrently). At time t_{b4}, device D2 may receive the plurality of ACK2 frames from device D1, and may record the TOA of each of the ACK2 frames (562).

Device D2 may embed timestamps in each of a plurality of FTM_3 frames, may concurrently (or substantially concurrently) transmit the plurality of FTM_3 frames to device D1 on respective ones of the plurality of wireless channels at time t_{c1}, and may record the TOD of each of the FTM_3 frames (563). Thus, as depicted in FIG. 5E, device D2 may transmit an FTM_3₁ frame to device D1 on wireless channel CH₁, may transmit an FTM_3₂ frame to device D1 on wireless channel CH₂, and may transmit an FTM_3₃ frame to device D1 on wireless channel CH₃, concurrently (or substantially concurrently).

At time t_{c2}, device D1 may concurrently (or substantially concurrently) receive the plurality of FTM_3 frames, and may decode the embedded timestamps in each of the received FTM_3 frames (564). Upon receiving the FTM_3 frames at time t_{c2}, device D1 has timestamp values for times t_{b1}, t_{b2}, t_{b3}, and t_{b4} that correspond to the TOD of each of the plurality of FTM_2 frames transmitted from device D2, the TOA of each of the plurality of FTM_2 frames received at device D1, the TOD of each of the plurality of ACK2 frames transmitted from device D1, and the TOA of each of the plurality of ACK2 frames received at device D2, respectively.

In some other implementations, device D2 may transmit the plurality of FTM_2 frames to device D1 at the same or similar time, device D1 may transmit the plurality of ACK2 frames to device D2 at the same or similar time, device D2 may transmit the plurality of FTM_3 frames to device D1 at the same or similar time, and device D1 may transmit the plurality of ACK3 frames to device D2 at the same or similar time.

Thereafter, device D1 may determine an RTT value for each of the plurality of sets of FTM and ACK frame exchanges, and may then determine the distance between device D1 and device D2 based on the plurality of RTT values, for example, in the manner described above with respect to FIGS. 5A and 5C.

It is noted that although each of the times t₁-t₄, tₐ₁-tₐ₄, t_{b1}-t_{b4}, and t_{c1}-t_{c4} is depicted as a single time in the example of FIG. 5E, each of the times t₁-t₄, tₐ₁-tₐ₄, t_{b1}-t_{b4}, and t_{c1}-t_{c4} may represent three slightly different times, for example, due to the orientation of device D1's antennas, the orientation of device D2's antennas, multipath effects, the availability of channels CH₁-CH₃, and other factors.

FIG. 5G is a signal diagram of another example ranging operation 565, and FIG. 5H is a sequence diagram 570 depicting the example ranging operation 565 of FIG. 5G. The example ranging operation 565 is shown to include substantially simultaneous ranging operations between a first device D1 and each of a plurality of other devices D2-D4. Devices D1-D4 may each be, for example, an access point (such as AP 110 of FIG. 1), a station (such as one of stations STA1-STA4 of FIG. 1), or another suitable wireless device (such as wireless device 200 of FIG. 2). As depicted in FIG. 5G, devices D1 and D2 are separated by a distance d_{1,2}, devices D1 and D3 are separated by a distance d_{1,3}, and devices D1 and D4 are separated by a distance d_{1,4}. The example ranging operations 565 of FIG. 5G may be suitable, for example, when only device D1 supports SBS and DBS operations (such as when devices D2-D4 support only single-channel operation).

At times t_{1,2}, t_{1,3}, and t_{1,4}, each of respective devices D2-D4 may announce its multi-channel simultaneous capabilities (or its inability to transmit/receive on multiple channels simultaneously) to device D1, for example, so that device D1 is informed that each of devices D2-D4 is capable of only single-channel operations and the particular channel upon which each of devices D2-D4 operates (571). It is noted that because devices D2-D4 may not be synchronized with device D1, the times t_{1,2}, t_{1,3}, and t_{1,4} may be different from one another, and thus the relative similarity of times t_{1,2}, t_{1,3}, and t_{1,4} depicted in the example of FIG. 5H is merely illustrative (although for some implementations, it may be possible that devices D2-D4 announce their multi-channel simultaneous capabilities at similar times).

As described above with respect to FIG. 5A, for implementations in which devices such as devices D2-D4 are access points, each of devices D2-D4 may embed or append the multi-channel simultaneous capability IE (such as indicating support for only single-channel operations) into a beacon frame. For implementations in which device D1 is a station, device D1 may elicit, from each of devices D2-D4, a response that includes the multi-channel simultaneous capability IE (such as indicating support for only single-channel operations), for example, by transmitting a probe request, an association request, an ANQP query request, or other suitable frame to devices D2-D4. Although devices D2-D4 are depicted in the example of FIG. 5G as transmitting announcement frames at the same time, for some other implementations, each of devices D2-D4 may transmit a respective announcement frame at a slightly different time, for example, depending upon the availability of channels CH₁-CH₃.

For the example shown in FIG. 5G, device D2 may transmit a first announcement frame to device D1 on wireless channel CH₁, device D3 may transmit a second announcement frame to device D1 on wireless channel CH₂, and device D4 may transmit a third announcement frame to device D1 on wireless channel CH₃, concurrently (or substantially concurrently) (such as if all channels CH₁-CH₃ are available). Device D1 may receive the first announcement frame at time t_{2,2}, may receive the second announcement frame at time t_{2,3}, and may receive the third announcement frame at time t_{2,4} (572). Note that time t_{2,3} may occur after time t_{2,2} because the distance d_{1,3} between devices D1 and D3 is greater than the distance d_{1,2} between devices D1 and D2. Similarly, time t_{2,4} may occur after time t_{2,3} because the distance d_{1,4} between devices D1 and D4 is greater than the distance d_{1,3} between devices D1 and D3.

Then, at time t₃, device D1 may concurrently (or substantially concurrently) transmit (such as if all channels CH₁-CH₃ are available) an FTM_REQ frame to each of devices D2-D4 on a respective one of the plurality of wireless channels (573). In some aspects, device D1 may transmit an FTM_REQ₁ frame to device D2 on wireless channel CH₁ at time t_{3,2}, may transmit an FTM_REQ₂ frame to device D3 on wireless channel CH₂ at time t_{3,3}, and may transmit an FTM_REQ₃ frame to device D4 on wireless channel CH₃ at time t_{3,4}. Device D2 may receive the FTM_REQ₁ frame at time t_{4,2}, device D3 may receive the FTM_REQ₂ frame at time t_{4,3} and device D4 may receive the FTM_REQ₃ frame at time t_{4,4} (574).

At time t₅, devices D2-D4 may each concurrently (or substantially concurrently) transmit (such as if all channels CH₁-CH₃ are available) a response to device D1 on a respective one of the plurality of wireless channels (575). In some aspects, device D2 may transmit a first FTM acknowledgement (ACK₁) frame to device D1 on wireless channel CH₁ at time t_{5,2}, device D3 may transmit an ACK₂ frame to device D1 on wireless channel CH₂ at time t_{5,3}, and device D4 may transmit an ACK₃ frame to device D1 on wireless channel CH₃ at time t_{5,4}. At times t_{6,2}, t_{6,3}, and t_{6,4}, device D1 may receive the responses ACK₁-ACK₃ from respective devices D2-D4 (576).

Thereafter, devices D2-D4 may initiate separate exchanges of sets of FTM and ACK frames with device D1 on the plurality of wireless channels. More specifically, each of devices D2-D4 may concurrently (or substantially concurrently) transmit (such as if all channels CH₁-CH₃ are available) a corresponding FTM_1 frame to device D1 on a respective one of the plurality of wireless channels CH₁-CH₃ (577). In some aspects, device D2 may transmit an FTM_1₁ frame to device D1 on wireless channel CH₁ at time t_{a1,2}, device D3 may transmit an FTM_1₂ frame to device D1 on wireless channel CH₂ at time t_{a1,3}, and device D4 may transmit an FTM_1₃ frame to device D1 on wireless channel CH₃ at time t_{a1, 4}. At times t_{a2,2}, t_{a2,3}, and t_{a2,4}, device D1 may receive the plurality of FTM_1 frames transmitted from respective devices D2-D4 on wireless channels CH₁-CH₃, and may record the TOA of each of the received FTM_1 frames (578).

At time tₐ₃, device D1 may concurrently (or substantially concurrently) transmit (such as if all channels CH₁-CH₃ are available) a corresponding ACK1 frame to each of devices D2-D4 on a respective one of the plurality of wireless channels (579). In some aspects, device D1 may transmit an ACK11 frame to device D2 on wireless channel CH₁ at time t_{a3,2}, may transmit an ACK1₂ frame to device D3 on wireless channel CH₂ at time t_{a3,3}, and may transmit an ACK1₃ frame to device D4 on wireless channel CH₃ at time t_{a3,4}.

Then, devices D2-D4 may receive the ACK1 frames from device D1, and may record the TOAs of the ACK1 frames (580). For example, device D2 may receive the ACK11 frame from device D1 on wireless channel CH₁ at time t_{a4,2} device D3 may receive the ACK1₂ frame from device D1 on wireless channel CH₂ at time t_{a4,3}, and device D4 may receive the ACK13 frame from device D1 on wireless channel CH₃ at time t_{a4,4}.

Devices D2-D4 may embed timestamps in corresponding FTM_2 frames, may concurrently (or substantially concurrently) transmit (such as if all channels CH₁-CH₃ are available) the corresponding FTM_2 frames to device D1 at time t_{b1}, and may record the TODs of the corresponding FTM_2 frames (581). In some aspects, device D2 may transmit an FTM_2₁ frame to device D1 on wireless channel CH₁ at time t_{b1,2}, device D3 may transmit an FTM_2₂ frame to device D1 on wireless channel CH₂ at time t_{b1,3}, and device D4 may transmit an FTM_2₃ frame to device D1 on wireless channel CH₃ at time t_{b1,4}. The FTM_2₁ frame may include timestamps for the TOD of the FTM_1₁ frame and the TOA of the ACK1₁ frame (such as times t_{a1,2} and t_{a4,2})₉ the FTM_2₂ frame may include timestamps for the TOD of the FTM_1₂ frame and the TOA of the ACK1₂ frame (such as times t_{a1,3} and t_{a4,3}), and the FTM_2₃ frame may include timestamps for the TOD of the FTM_1₃ frame and the TOA of the ACK1₃ frame (such as times t_{a1,4} and t_{a4,4}). In some other implementations, one or more of the FTM_2₁-FTM_2₃ frames may instead include a difference time value, for example, as described above with respect to FIG. 5A.

Then, device D1 may receive the plurality of FTM_2 frames from respective devices D2-D4, and may decode the embedded timestamps in each of the received FTM_2 frames (582). More specifically, device D1 may receive the FTM_2₁ frame on wireless channel CH₁ at time t_{b2,2}, may receive the FTM_2₂ frame on wireless channel CH₂ at time t_{b2,3}, and may receive the FTM_2₃ frame on wireless channel CH₃ at time t_{b2,4}. Upon receiving the FTM_2 frames, device D1 has timestamp values that correspond to the TODs of each of the plurality of FTM_1 frames transmitted from devices D2-D4, the TOAs of each of the plurality of FTM_1 frames received at device D1, the TODs of each of the plurality of ACK1 frames transmitted from device D1, and the TOAs of each of the plurality of ACK1 frames received at respective devices D2-D4.

In some other implementations, device D1 may transmit the plurality of FTM_REQ frames to devices D2-D4 at the same or similar time, may transmit the plurality of ACK1 frames to devices D2-D4 at the same or similar time, and may transmit the plurality of ACK2 frames to devices D2-D4 at the same or similar time.

Thereafter, device D1 may determine an RTT value for each of the plurality of sets of FTM and ACK frame exchanges, and may then determine the distances between device D1 and each of devices D2-D4 based on the plurality of RTT values (583). For example, device D1 may determine an RTT value indicative of the distance d_{1,2} between devices D1 and D2 using the expression RTT_{1,2}=(t_{a4,2}−t_{a3,2})+(t_{a2,2}−t_{a1,2}), may determine an RTT value indicative of the distance d_{1,3} between devices D1 and D3 using the expression RTT_{1,3}=(t_{a4,3}−t_{a3,3})+(t_{a2,3}−t_{a1,3}), and may determine an RTT value indicative of the distance d_{1,4} between devices D1 and D4 using the expression RTT_{1,4}=(t_{a4,4}−t_{a3,4})+(t_{a2,4}−t_{a1,4}).

FIG. 6A depicts an example management frame 600. The management frame 600 may be used as a beacon frame, a probe request, and an association request for one or more of the example ranging operations described above with respect to FIGS. 5A-5H. The management frame 600 is depicted in FIG. 6A as including a frame control field 601, a duration field 602, a destination address (DA) field 603, a source address (SA) field 604, a BSSID field 605, a sequence control field 606, a frame body 607, and a frame check sequence (FCS) field 608. In some implementations, the frame control field 601 may be 2 bytes, the duration field 602 may be 2 bytes, the DA field 603 may be 6 bytes, the SA field 604 may be 6 bytes, the BSSID field 605 may be 6 bytes, the sequence control field 606 may be 2 bytes, the frame body 607 maybe of a variable length, and the FCS field 608 may be 4 bytes. In some other implementations, the fields of the management frame 600 of FIG. 6A may be of other suitable lengths.

The frame control field 601 may store information indicating a type of management frame 600. More specifically, the frame control field 601 is shown to include a Type field 601A and a Sub-type field 601B. The Type field 601A may store a value of “00” to indicate that frame 600 is a management frame, and the Sub-type field 601B may store information indicating a management frame type. For one example, if frame 600 is used as a beacon frame, then the Sub-type field 601B may store a value of 1000. For another example, if frame 600 is used as a probe request, then the Sub-type field 601B may store a value of 0100. For another example, if frame 600 is used as an association request, then the Sub-type field 601B may store a value of 0000.

The DA field 603 may be used to store the address of a receiving device (or devices if frame 600 is a multi-cast or broadcast frame). The SA field 604 may be used to store the address of the transmitting device. The BSSID field 605 may be used to store BSSID information. The sequence control field 606 may be used to assign sequence numbers and fragment numbers of aggregated data units. The frame body 607 may store a number of information elements (IE). The FCS field 608 may store a frame control sequence (such as for error detection).

For the example of FIG. 6A, the frame body 607 is shown to include a multi-channel simultaneous capability IE 800 that may store SBS capabilities, DBS capabilities, and channel information pertaining to one or more ranging operations. The multi-channel simultaneous capability IE 800 is described in more detail with respect to FIGS. 8A and 8B.

FIG. 6B depicts an example co-located basic service set identification (BSSID) list sub-element 620. The co-located BSSID list sub-element 620 may be included within or appended to an ANQP query request and an ANQP query response. The co-located BSSID list sub-element 620 is shown to include a sub-element ID field 621, a length field 622, a channel numbers field 623, and a plurality of channel information fields 624(1)-624(m). In some implementations, the sub-element ID field 621 may include one byte, the Length field 622 may include one byte, the channel numbers field 623 may include one byte, and each of the channel information fields 624(1)-624(m) may include a variable number of bytes (although in some other implementations, other field lengths may be used). The sub-element ID field 621 may store an element ID value indicating that the co-located BSSID list sub-element 620 contains multi-channel simultaneous capabilities for a device. The Length field 622 may store a value indicating a length (in bytes) of the channel numbers field 623 and all the channel information fields 624(1)-624(m).

The channel numbers field 623 may store information indicating how many channels upon which a device may simultaneously transmit and receive signals. In some aspects, the channel numbers field 623 may include 8 bits that together may indicate as many as M=2⁸=256 different channels for simultaneous operation capabilities. Each of the channel information fields 624(1)-624(m) may store channel information for a corresponding one of the channels upon which the device is capable of simultaneous operations. As depicted in FIG. 6B, each of the channel information fields 624(1)-624(m) may be the example channel information field 630. More specifically, in some implementations, the channel information field 630 may include a channel number field 631, a channel bandwidth field 632, a MaxBSSID indicator field 633, and a number of optional BSSID fields 634(1)-634(n).

The channel number field 631 may include a number of bits that indicate the location of a corresponding channel. In some aspects, the channel number bits may indicate whether the corresponding channel is one of channels 1-14 in the 2.4 GHz frequency band or one of channels 36-165 in the 5 GHz frequency band.

The channel bandwidth field 632 may include a number of bits that indicate the bandwidth of the corresponding channel. In some aspects, a decimal value of “0” represented by the channel bandwidth bits may indicate a 20 MHz channel bandwidth, a decimal value of “1” represented by the channel bandwidth bits may indicate a 40 MHz channel bandwidth, a decimal value of “2” represented by the channel bandwidth bits may indicate an 80 MHz channel bandwidth, a decimal value of “3” represented by the channel bandwidth bits may indicate an 80 MHz channel bandwidth, a decimal value of “3” represented by the channel bandwidth bits may indicate a 160 MHz channel bandwidth, and a decimal value of “4” represented by the channel bandwidth bits may indicate an 80+80 MHz channel bandwidth. The remaining decimal values 5-255 represented by the channel bandwidth bits may be reserved.

The MaxBSSID indicator field 633 may indicate a maximum possible number of BSSs, including the reference BSS, which share the same antenna connector and have the same 48 most significant bits (MSBs) of the BSSIDs. When the BSSIDs of the co-located BSSs are configured by the reporting device but not represented by the MaxBSSID indicator field 633, then the BSSID fields 634(1)-634(n) may be present in the co-located BSSID list sub-element 620, for example, to provide an explicit list of the BSSID values.

FIG. 7A depicts an example FTM request (FTM_REQ) frame 700. The FTM_REQ frame 700 may be used in the example ranging operation 500 of FIG. 5A, the example ranging operation 525 of FIG. 5C, the example ranging operation 545 of FIG. 5E, and in the example ranging operation 565 of FIG. 5G. The FTM_REQ frame 700 may include a category field 701, a public action field 702, a trigger field 703, an optional location civic information (LCI) measurement request field 704, an optional location civic measurement request field 705, an optional FTM parameters field 706, and a multi-channel simultaneous capability IE 800.

The fields 701-706 of the FTM_REQ frame 700 are well-known, and therefore are not discussed in detail herein. The multi-channel simultaneous capability IE 800 may store multi-channel simultaneous capabilities and channel information pertaining to each of a plurality of wireless channels to be used for one or more ranging operations described herein, for example, as described in more detail with respect to FIGS. 8A and 8B.

FIG. 7B depicts an example FTM frame 710. The FTM frame 710 may be one implementation of the FTM_1 frames, FTM_2 frames, and the FTM_3 frames used in one or more of the example ranging operations 500, 525, 545, and 565 of FIGS. 5A, 5C, 5E, and 5G, respectively. The FTM frame 710 may include a category field 711, a public action field 712, a dialog token field 713, a follow up dialog token field 714, a TOD field 715, a TOA field 716, a TOD error field 717, a TOA error field 718, an optional LCI report field 719, an optional location civic report field 720, an optional FTM parameters field 721, and a multi-channel simultaneous capability IE 800.

The fields 711-721 of the FTM frame 710 are well-known, and therefore are not discussed in detail herein. The multi-channel simultaneous capability IE 800 may store multi-channel simultaneous capabilities and channel information pertaining to each of a plurality of wireless channels to be used for one or more ranging operations described herein, for example, as described in more detail with respect to FIGS. 8A and 8B.

FIG. 8A depicts an example multi-channel simultaneous capability information element (IE) 800. The multi-channel simultaneous capability IE 800 may include an Element ID field 801, a Length field 802, a channel numbers field 803, and a plurality of channel information fields 804(1)-804(m). For some implementations, the Element ID field 801 may include one byte, the Length field 802 may include one byte, the channel numbers field 803 may include one byte, and each of the channel information fields 804(1)-804(m) may include a variable number of bytes (although for other implementations, other field lengths may be used). The Element ID field 801 may store an element ID value indicating that IE 800 contains multi-channel simultaneous capabilities for a device. The Length field 802 may store a value indicating a length (in bytes) of the channel numbers field 803 and all the channel information fields 804(1)-804(m).

The channel numbers field 803 may store information indicating how many channels upon which a device may simultaneously transmit and receive signals. In some aspects, the channel numbers field 803 may include 8 bits that together may indicate as many as M=2⁸=256 different channels for simultaneous operation capabilities.

Each of the channel information fields 804(1)-804(m) may store channel information for a corresponding one of the channels upon which the device is capable of simultaneous operations (or substantially simultaneous operations). More specifically, in some implementations, the channel information may indicate a location (such as channel number) of a corresponding channel, a frequency band of the corresponding channel, and a bandwidth of the corresponding channel.

FIG. 8B depicts an example channel information field 810. The channel information field 810 may be used as one or more of the channel information fields 804(1)-804(m) of multi-channel simultaneous capability IE 800. The channel information field 810 is shown in FIG. 8B to include an 8-bit channel number field 811, an 8-bit channel bandwidth field 812, and a plurality of 48-bit BSSID fields 813(1)-813(k). For other implementations, the fields 811-813 of channel information field 810 may be of other suitable lengths.

Bits b₀-b₇ (in the channel number field 811) may indicate the location of a corresponding channel. In some aspects, the bits b₀-b₇ may indicate whether the corresponding channel is one of channels 1-14 in the 2.4 GHz frequency band or one of channels 36-165 in the 5 GHz frequency band.

Bits b₈-b₁₅ (in the channel bandwidth field 812) may indicate the bandwidth of the corresponding channel. In some aspects, a decimal value of “0” represented by bits b₈-b₁₅ may indicate a 20 MHz channel bandwidth, a decimal value of “1” represented by bits b₈-b₁₅ may indicate a 40 MHz channel bandwidth, a decimal value of “2” represented by bits b₈-b₁₅ may indicate an 80 MHz channel bandwidth, a decimal value of “3” represented by bits b₈-b₁₅ may indicate an 80 MHz channel bandwidth, a decimal value of “3” represented by bits b₈-b₁₅ may indicate a 160 MHz channel bandwidth, and a decimal value of “4” represented by bits b₈-b₁₅ may indicate an 80+80 MHz channel bandwidth. The remaining decimal values 5-255 represented by bits b₈-b₁₅ may be reserved.

Bits b₁₆-b₆₃ (in the first BSSID field 813(1)) may be used to indicate a first BSSID value of the corresponding channel, bits b₆₄-b₁₁₁ (in the second BSSID field 813(2)) may be used to indicate a second BSSID value of the corresponding channel, and so on, where bits b₄₈ₖ₋₃₂-b₄₈ₖ₊₁₅ (in the k^{th} BSSID field 813(k)) may be used to indicate the k^{th} BSSID value of the corresponding channel.

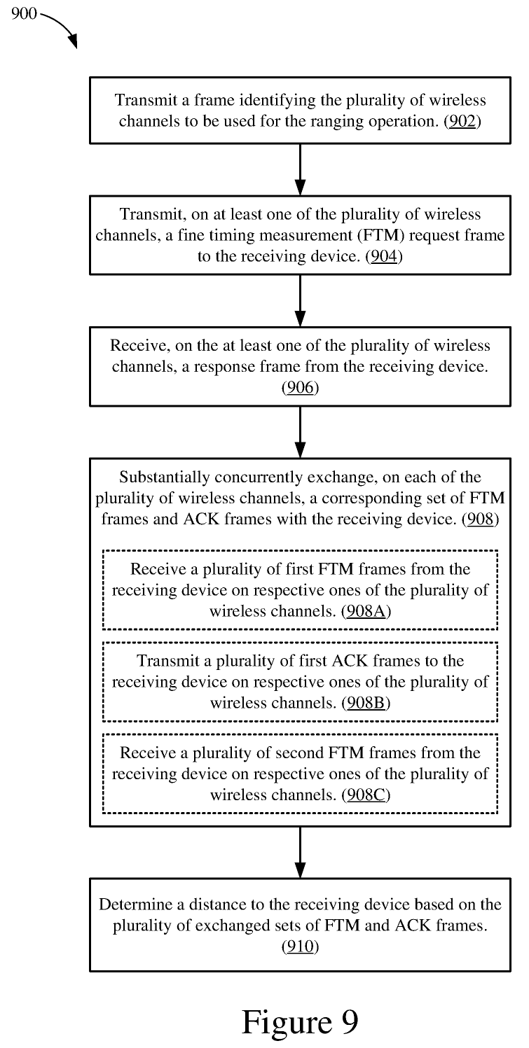

FIG. 9 shows an illustrative flow chart depicting an example ranging operation 900. The ranging operation 900 may be performed between a transmitting device and a receiving device on a plurality of wireless channels. The transmitting device may be any suitable wireless device including, for example, one of the stations STA1-STA4 of FIG. 1, the AP 110 of FIG. 1, or the wireless device 200 of FIG. 2. Similarly, the receiving device may be any suitable wireless device including, for example, one of the stations STA1-STA4 of FIG. 1, the AP 110 of FIG. 1, or the wireless device 200 of FIG. 2.

In some implementations, the transmitting device can transmit a frame identifying the plurality of wireless channels to be used for the ranging operation (902). In some aspects, the frame can be one of a beacon frame, a probe request, an association request, or an access network query protocol (ANQP) query request. The frame can indicate at least one of a capability to transmit and receive signals on multiple wireless channels at the same time (or at substantially the same time) and an indication of how many different wireless channels upon which a transmitting device is capable of simultaneous operations (or substantially simultaneous operations). The frame also can include an information element identifying at least one of a frequency band, a channel number, and a channel bandwidth of each of the plurality of wireless channels to be used for the ranging operation.

The transmitting device can transmit, on at least one of the plurality of wireless channels, a fine timing measurement (FTM) request frame to the receiving device (904). In some implementations, the FTM request frame can identify the plurality of wireless channels to be used for the ranging operation. For such implementations, the FTM request frame can indicate at least one of a capability to transmit signals on multiple wireless channels at the same time (or at substantially the same time) and an indication of how many different wireless channels upon which the transmitting device is capable of simultaneous operations (or substantially simultaneous operations). The FTM request frame also can indicate at least one of a frequency band, a channel number, and a channel bandwidth of each of the identified plurality of wireless channels.

The transmitting device can receive, on the at least one of the plurality of wireless channels, a response frame from the receiving device (906). The response frames can be any suitable frame that acknowledges reception of the FTM request frame. In some aspects, the response frames can be ACK frames.

The transmitting device can concurrently (or substantially concurrently) exchange, on each of the plurality of wireless channels, a corresponding set of FTM frames and acknowledgement (ACK) frames with the receiving device (908). In some implementations, the transmitting device can exchange corresponding sets of FTM frames and ACK frames with the receiving device by concurrently (or substantially concurrently) receiving a plurality of first FTM frames from the receiving device on respective ones of the plurality of wireless channels (908A), concurrently (or substantially concurrently) transmitting a plurality of first ACK frames to the receiving device on respective ones of the plurality of wireless channels (908B), and concurrently (or substantially concurrently) receiving a plurality of second FTM frames from the receiving device on respective ones of the plurality of wireless channels (908C).

Thereafter, the transmitting device can determine a distance to the receiving device based on the plurality of exchanged sets of FTM and ACK frames (910). For example, the transmitting device can determine an RTT value for each of the exchanged sets of FTM and ACK frames, and then derive the distance to the receiving device based on the determined RTT values.

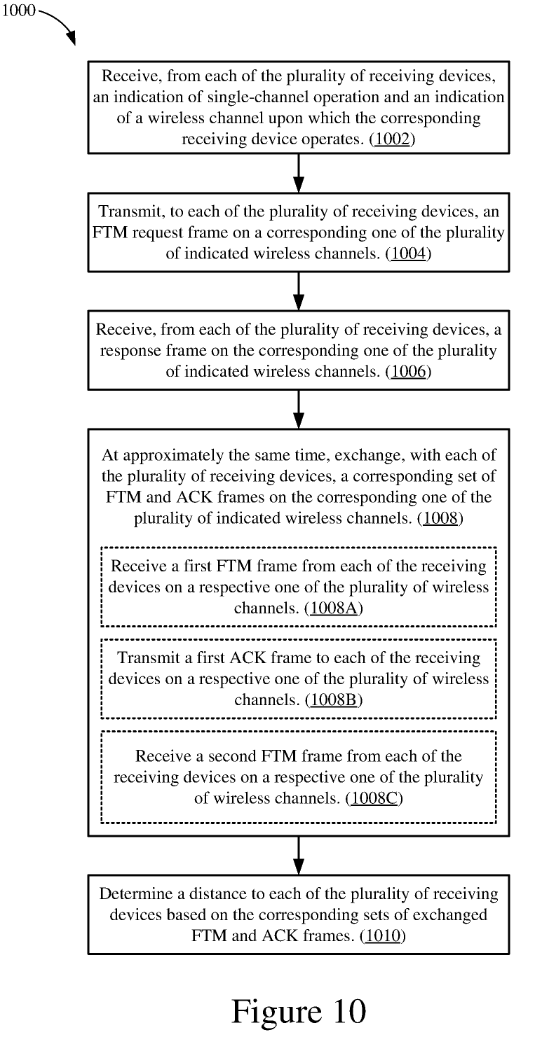

FIG. 10 shows an illustrative flow chart depicting another example ranging operation 1000. The ranging operation 1000 may be performed between a transmitting device and a plurality of receiving devices on a plurality of wireless channels. The transmitting device may be any suitable wireless device including, for example, one of the stations STA1-STA4 of FIG. 1, the AP 110 of FIG. 1, or the wireless device 200 of FIG. 2. Similarly, the receiving devices may be any suitable wireless device including, for example, one of the stations STA1-STA4 of FIG. 1, the AP 110 of FIG. 1, or the wireless device 200 of FIG. 2.

The transmitting device can receive, from each of the plurality of receiving devices, an indication of single-channel operation and an indication of a wireless channel upon which the corresponding receiving device operates (1002). In some implementations, the indication can be contained within one of a beacon frame, a probe request, an association request, or an access network query protocol (ANQP) query request.

The transmitting device can transmit, to each of the plurality of receiving devices, an FTM request frame on a corresponding one of the plurality of indicated wireless channels (1004). In some implementations, the FTM request frame can identify the wireless channels to be used for the ranging operation. For such implementations, the FTM request frame can indicate at least one of a capability to transmit signals on multiple wireless channels at the same time (or at substantially the same time) and an indication of how many different wireless channels upon which the transmitting device is capable of simultaneous operations (or substantially simultaneous operations). The FTM request frame also can indicate at least one of a frequency band, a channel number, and a channel bandwidth of each of the wireless channels.

The transmitting device can receive, from each of the plurality of receiving devices, a response frame on the corresponding one of the plurality of indicated wireless channels (1006). The response frames can be any suitable frame that acknowledges reception of the FTM request frame. In some aspects, the response frames can be ACK frames.

The transmitting device can, at approximately the same time, exchange, with each of the plurality of receiving devices, a corresponding set of FTM frames and ACK frames on the corresponding one of the plurality of indicated wireless channels (1008). In some implementations, the transmitting device can exchange each set of FTM and ACK frames by receiving a first FTM frame from each receiving device on a respective one of the plurality of wireless channels (1008A), transmitting a first ACK frame to each receiving device on a respective one of the plurality of wireless channels (1008B), and receiving a second FTM frame from each receiving device on a respective one of the plurality of wireless channels (1008C).

Thereafter, the transmitting device can determine a distance to each of the receiving devices based on the corresponding sets of exchanged FTM and ACK frames (1010). For example, the transmitting device can determine an RTT value for each of the exchanged sets of FTM and ACK frames, and then derive the distance to each of the receiving devices based on the determined RTT values.

As used herein, a phrase referring to “at least one of” a list of items refers to any combination of those items, including single members. As an example, “at least one of: a, b, or c” is intended to cover: a, b, c, a-b, a-c, b-c, and a-b-c. In addition, although described in terms of an infrastructure WLAN system including one or more APs and a number of STAs, the subject matter of this disclosure is equally applicable to other WLAN systems including, for example, multiple WLANs, Independent Basic Service Set (IBSS) systems, peer-to-peer systems (such as operating according to the Wi-Fi Direct protocols), and Hotspots. In addition, although described herein in terms of exchanging data frames between wireless devices, the subject matter of this disclosure may be applied to the exchange of any data unit, packet, frame, or signal between wireless devices. Thus, the term “frame” may include any signal, frame, packet, or data unit such as, for example, protocol data units (PDUs), media access control (MAC) protocol data units (MPDUs), and physical layer convergence procedure protocol data units (PPDUs). The term “A-MPDU” may refer to aggregated MPDUs. Further, as used herein, the term “ranging frame” may refer to any frame, transmitted between two devices, that forms the basis of determining an RTT value indicative of a distance between the two devices. Thus, as used herein, the ranging frames may include, for example, fine timing measurement (FTM) frames and acknowledgement (ACK) frames.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of performing a ranging operation on a plurality of wireless channels, comprising:
transmitting, on at least one of the plurality of wireless channels, a fine timing measurement (FTM) request frame to a receiving device;
receiving, on the at least one of the plurality of wireless channels, a response frame from the receiving device; and
substantially concurrently exchanging, on each of the plurality of wireless channels, a corresponding set of FTM frames and acknowledgement (ACK) frames with the receiving device.

2. The method of claim 1, further comprising:
determining a distance to the receiving device based on the plurality of substantially concurrently exchanged sets of FTM and ACK frames.

3. The method of claim 1, wherein the FTM request frame indicates at least one of a capability to transmit signals on multiple wireless channels at substantially the same time and an indication of how many different wireless channels upon which a transmitting device is capable of substantially simultaneous operations.

4. The method of claim 1, wherein the FTM request frame identifies the plurality of wireless channels to be used for the ranging operation.

5. The method of claim 4, wherein the FTM request frame indicates at least one of a frequency band, a channel number, and a channel bandwidth of each of the identified plurality of wireless channels.

6. The method of claim 1, wherein:
the transmitting comprises substantially concurrently transmitting, on each of the plurality of wireless channels, a corresponding FTM request frame to the receiving device; and
the receiving comprises substantially concurrently receiving, on each of the plurality of wireless channels, a corresponding response frame from the receiving device.

7. The method of claim 1, further comprising:
transmitting, prior to transmission of the FTM request frame, a frame identifying the plurality of wireless channels to be used for the ranging operation.

8. The method of claim 7, wherein the frame indicates at least one of a capability to transmit and receive signals on multiple wireless channels at substantially the same time and an indication of how many different wireless channels upon which a transmitting device is capable of substantially simultaneous operations.

9. The method of claim 7, wherein the frame includes an information element identifying at least one of a frequency band, a channel number, and a channel bandwidth of each of the plurality of wireless channels to be used for the ranging operation.

10. The method of claim 7, wherein the frame is one of a beacon frame, a probe request, an association request, or an access network query protocol (ANQP) query request.

11. The method of claim 1, wherein the substantially concurrently exchanging comprises:
receiving a plurality of first FTM frames from the receiving device on respective ones of the plurality of wireless channels;
transmitting a plurality of first ACK frames to the receiving device on respective ones of the plurality of wireless channels; and
receiving a plurality of second FTM frames from the receiving device on respective ones of the plurality of wireless channels.

12. The method of claim 11, wherein each of the plurality of second FTM frames includes time of arrival (TOA) and time of departure (TOD) information of the first ACK frame and the first FTM frame, respectively, exchanged on a corresponding one of the plurality of wireless channels.

13. An apparatus for performing a ranging operation on a plurality of wireless channels, comprising:
one or more transceivers configured to transmit and receive wireless signals;
one or more processors; and
a memory comprising instructions that, when executed by the one or more processors, causes the apparatus to:
transmit, on at least one of the plurality of wireless channels, a fine timing measurement (FTM) request frame to a receiving device;
receive, on the at least one of the plurality of wireless channels, a response frame from the receiving device; and
substantially concurrently exchange, on each of the plurality of wireless channels, a corresponding set of FTM frames and acknowledgement (ACK) frames with the receiving device.

14. The apparatus of claim 13, wherein execution of the instructions causes the apparatus to further:
determine a distance to the receiving device based on the plurality of substantially concurrently exchanged sets of FTM and ACK frames.

15. The apparatus of claim 13, wherein the FTM request frame indicates at least one of a capability to transmit signals on multiple wireless channels at substantially the same time and an indication of how many different wireless channels upon which the apparatus is capable of substantially simultaneous operations.

16. The apparatus of claim 13, wherein the FTM request frame identifies the plurality of wireless channels to be used for the ranging operation.

17. The apparatus of claim 16, wherein the FTM request frame indicates at least one of a frequency band, a channel number, and a channel bandwidth of each of the identified plurality of wireless channels.

18. The apparatus of claim 13, wherein:
the transmitting comprises substantially concurrently transmitting, on each of the plurality of wireless channels, a corresponding FTM request frame to the receiving device; and
the receiving comprises substantially concurrently receiving, on each of the plurality of wireless channels, a corresponding response frame from the receiving device.

19. The apparatus of claim 13, wherein execution of the instructions causes the apparatus to further:
transmit, prior to transmission of the FTM request frame, a frame identifying the plurality of wireless channels to be used for the ranging operation.

20. The apparatus of claim 19, wherein the frame indicates at least one of a capability to transmit and receive signals on multiple wireless channels at substantially the same time and an indication of how many different wireless channels upon which the apparatus is capable of substantially simultaneous operations.

21. The apparatus of claim 19, wherein the frame includes an information element identifying at least one of a frequency band, a channel number, and a channel bandwidth of each of the plurality of wireless channels to be used for the ranging operation.

22. The apparatus of claim 19, wherein the frame is one of a beacon frame, a probe request, an association request, or an access network query protocol (ANQP) query request.

23. The apparatus of claim 13, wherein execution of the instructions for substantially concurrently exchanging causes the apparatus to:
receive a plurality of first FTM frames from the receiving device on respective ones of the plurality of wireless channels;
transmit a plurality of first ACK frames to the receiving device on respective ones of the plurality of wireless channels; and
receive a plurality of second FTM frames from the receiving device on respective ones of the plurality of wireless channels.

24. The apparatus of claim 23, wherein each of the plurality of second FTM frames includes time of arrival (TOA) and time of departure (TOD) information of the first ACK frame and the first FTM frame, respectively, exchanged on a corresponding one of the plurality of wireless channels.

25. A method of performing concurrent ranging operations with a plurality of receiving devices, comprising:
receiving, from each of the plurality of receiving devices, an indication of single-channel operation and an indication of a wireless channel upon which a corresponding one of the receiving devices operates;
transmitting, to each of the plurality of receiving devices, a fine timing measurement (FTM) request frame on a corresponding one of the plurality of indicated wireless channels;
receiving, from each of the plurality of receiving devices, a response frame on the corresponding one of the plurality of indicated wireless channels; and
at approximately the same time, exchanging, with each of the plurality of receiving devices, a corresponding set of FTM frames and acknowledgement (ACK) frames on the corresponding one of the plurality of indicated wireless channels.

26. The method of claim 25, further comprising:
determining a distance to each of the plurality of receiving devices based on the corresponding sets of exchanged FTM and ACK frames.

27. The method of claim 25, wherein the indication is contained within one of a beacon frame, a probe request, an association request, or an access network query protocol (ANQP) query request.

28. The method of claim 25, wherein the FTM request frames are transmitted to each of the plurality of receiving devices at the same or similar time.

29. The method of claim 25, wherein the exchanging comprises:
receiving a first FTM frame from each of the receiving devices on a respective one of the plurality of wireless channels;
transmitting a first ACK frame to each of the receiving devices on a respective one of the plurality of wireless channels; and
receiving a second FTM frame from each of the receiving devices on a respective one of the plurality of wireless channels.

30. The method of claim 29, wherein each of the second FTM frames includes time of arrival (TOA) and time of departure (TOD) information of a corresponding one of the first ACK frames and a corresponding one of the first FTM frames, respectively.
